(19) United States
(12) Patent Application Publication
(10) Pub. No.: US 2024/0178973 A1
(43) Pub. Date: May 30, 2024

(54) SWITCHING BETWEEN PHYSICAL DOWNLINK CONTROL CHANNEL (PDCCH) MONITORING CONFIGURATIONS OF SEARCH SPACE SET GROUPS (SSSGS)

(71) Applicant: Intel Corporation, Santa Clara, CA (US)

(72) Inventors: Yingyang Li, Beijing (CN); Gang Xiong, Portland, OR (US); Daewon Lee, Portland, OR (US); Yi Wang, Beijing (CN)

(21) Appl. No.: 18/549,518

(22) PCT Filed: Mar. 31, 2022
(86) PCT No.: PCT/US2022/022799

§ 371 Date: Sep. 7, 2023

Related U.S. Application Data
(60) Provisional application No. 63/168,848, filed on Mar. 31, 2021.
(60) Provisional application No. 63/174,944, filed on Apr. 14, 2021.
(60) Provisional application No. 63/250,173, filed on Sep. 29, 2021.
(60) Provisional application No. 63/296,132, filed on Jan. 3, 2022.
(60) Provisional application No. 63/302,431, filed on Jan. 24, 2022.

(51) Int. Cl. H04L 5/00; H04W 72/0446; H04W 72/23

(52) U.S. Cl. CPC H04L 5/0053; H04L 5/0091; H04W 72/0446; H04W 72/23

(57) ABSTRACT

The present invention relates to an apparatus comprising: memory to store configuration information for a first search space set group (SSSG) and a second SSSG associated with respective first and second physical downlink control channel (PDCCH) monitoring configurations; and processing circuitry, coupled with the memory, to retrieve the configuration information from the memory, and encode a message for transmission to a user equipment (UE) that includes the configuration information, wherein the configuration information includes an indication of a boundary for switching between the first SSSG and the second SSSG that is aligned with a boundary of a slot group.

### CROSS REFERENCE TO RELATED APPLICATION

The present application claims priority to: U.S. Provisional Patent Application No. 63/168,848, which was filed Mar. 31, 2021; U.S. Provisional Patent Application No. 63/174,944, which was filed Apr. 14, 2021; U.S. Provisional Patent Application No. 63/250,173, which was filed Sep. 29, 2021; U.S. Provisional Patent Application No. 63/296,132, which was filed Jan. 3, 2022; and U.S. Provisional Patent Application No. 63/302,431, which was filed Jan. 24, 2022.

### FIELD

Various embodiments generally may relate to the field of wireless communications. For example, some embodiments may relate to switching between different physical downlink control channel (PDCCH) monitoring configurations of search space set groups (SSSGs).

### BACKGROUND

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that target to meet vastly different and sometime conflicting performance dimensions and services. Such diverse multi-dimensional requirements are driven by different services and applications. In general, NR will evolve based on 3GPP LTE-Advanced with additional potential new Radio Access Technologies (RATs) to enrich people lives with better, simple and seamless wireless connectivity solutions. NR will enable everything connected by wireless and deliver fast, rich content and services.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of a short slot duration of a larger subcarrier spacing in accordance with various embodiments.

FIG. 2 illustrates an example of PDCCH monitoring in the first Y slots in every X consecutive slots in accordance with various embodiments.

FIG. 3 illustrates an example of PDCCH monitoring in Y slots in every X consecutive slots in accordance with various embodiments.

FIG. 4 illustrates an example of PDCCH monitoring with a span of up to Y=2 slots and a minimum distance X=4 slots in accordance with various embodiments.

FIG. 5 illustrates an example of PDCCH monitoring in the first Y slots in every X consecutive slots in accordance with various embodiments.

FIG. 6 illustrates an example of PDCCH monitoring in Y slots in every X consecutive slots in accordance with various embodiments.

FIG. 7 illustrates an example of PDCCH monitoring with a span of up to Y=2 slots and minimum distance X=4 slots in accordance with various embodiments.

FIG. 8 illustrates an example of different options for PDCCH monitoring capabilities associated with two SSSGs in accordance with various embodiments.

FIG. 9 illustrates an example of a common option for PDCCH monitoring capabilities with different X and Y associated with two SSSGs in accordance with various embodiments.

FIG. 10 illustrates an example of SSSG switching with X1=X2 in accordance with various embodiments.

FIG. 11 illustrates an example of SSSG switching with X1<X2 in accordance with various embodiments.

FIG. 12 illustrates an example of SSSG switching with X1<X2 in accordance with various embodiments.

FIG. 13 illustrates an example of a delay for PDCCH monitoring of a second SSSG in accordance with various embodiments.

FIG. 14 illustrates an example of PDCCH monitoring according to two SSSGs in accordance with various embodiments.

FIG. 15 illustrates an example of PDCCH monitoring according to a second SSSG in accordance with various embodiments.

FIG. 16 illustrates an example of PDCCH monitoring according to a second SSSG in accordance with various embodiments.

FIG. 17 illustrates an example of SSSG switching with a common value X and a common start slot of the Y slots in accordance with various embodiments.

FIG. 18 schematically illustrates a wireless network in accordance with various embodiments.

FIG. 19 schematically illustrates components of a wireless network in accordance with various embodiments.

FIG. 20 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 21, 22, and 23 depict examples of procedures for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

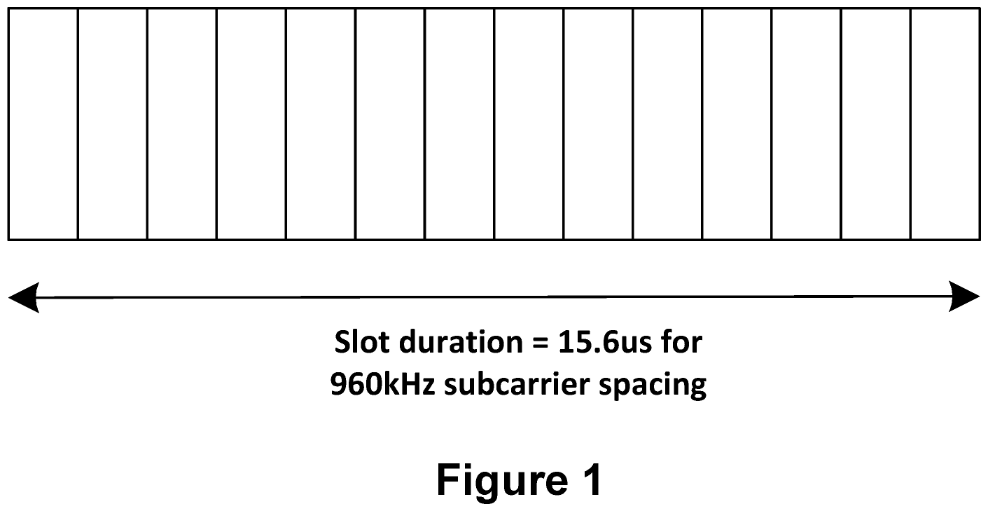

As defined in NR, one slot has 14 symbols. For system operating above 52.6 GHz carrier frequency, if larger subcarrier spacing (SCS), e.g., 960 kHz is employed, the slot duration can be very short. For instance, for SCS 960 kHz, one slot duration is approximately 15.6 μs as shown in FIG. 1.

In NR, a control resource set (CORESET) is a set of time/frequency resources carrying PDCCH transmissions. The CORESET is divided into multiple control channel element (CCE). A physical downlink control channel (PDCCH) candidate with aggregation level (AL) L consists of L CCEs. L could be 1, 2, 4, 8, 16. A search space set can be configured to a UE, which configures the timing for PDCCH monitoring and a set of CCEs carrying PDCCH candidates for the UE.

In NR Rel-15, the maximum number of monitored PDCCH candidates and non-overlapped CCEs for PDCCH monitoring are specified for the UE. When the subcarrier spacing is increased from 15 kHz to 120 kHz, maximum number of BDs and CCEs for PDCCH monitoring is reduced substantially. This is primarily due to UE processing capability with short symbol and slot duration. For system operating between 52.6 GHz and 71 GHz carrier frequency, when a large subcarrier spacing is introduced, it is envisioned that maximum number of BDs and CCEs for PDCCH monitoring would be further scaled down.

In Rel-16 NR-unlicensed (NR-U), search space set group (SSSG) switching was introduced. In a typical configuration, a default SSSG is configured with frequent PDCCH monitoring occasions at least for DCI format 2_0. Once a gNB gets the channel access after a successful listen-before-talk (LBT) operation, the gNB can quickly transmit a DCI 2_0 to indicate the channel occupation. During the gNB's channel occupation time (COT), UE can switch PDCCH monitoring according to a second SSSG configuration. Infrequent PDCCH monitoring in the second SSSG can be configured for UE power saving.

Various embodiments herein provide techniques for SSSG switching considering the constraint on maximum numbers of PDCCH candidates and non-overlapped CCEs for PDCCH monitoring in systems operating above 52.6 GHz carrier frequency.

In NR, when the subcarrier spacing (SCS) is increased from 15 kHz to 120 kHz, the maximum numbers of monitored PDCCH candidates and non-overlapped CCEs for PDCCH monitoring in a slot is reduced substantially. When a larger SCS is introduced, if UE can monitor PDCCHs in every slot, it is envisioned that the corresponding maximum numbers for PDCCH monitoring in a slot would be further scaled down, which results in limitation on PDCCH transmissions. As a solution, the corresponding maximum numbers for PDCCH monitoring can be defined in a group of slots. For example, the PDCCH monitoring can be configured in the first Y slots within every X consecutive slots, X>Y. Alternatively, the PDCCH monitoring can be configured in a span of up to Y consecutive slots and the distance between two adjacent spans is at least X slots. On the other hand, there are cases that frequent PDCCH monitoring, e.g. PDCCH monitoring per slot may be helpful. For example, PDCCH monitoring per slot allows quick channel access after LBT is successful. In this case, the corresponding maximum numbers for PDCCH monitoring can be still defined per slot.

In NR-U, search space set group (SSSG) switching is supported for the PDCCH monitoring of a UE. For example, if the UE doesn't detect the start of gNB-initiated channel occupation time (COT), UE keeps performing PDCCH monitoring following a first (default) SSSG configuration. On the other hand, inside the gNB-initiated COT, the UE can switch to PDCCH monitoring according to a second SSSG configuration. In NR-U, SSSG switching from the first SSSG to the second SSSG can be triggered by an indicator in DCI 2_0 or by the reception of any PDCCH in the first SSSG. SSSG switching from the second SSSG to the first SSSG can be triggered by an indicator in DCI 2_0, by the end of indicated channel occupation time (COT), or by the expire of a timer.

The first SSSG configuration and the second SSSG configuration may be associated with different PDCCH monitoring capabilities on the definition of maximum numbers of monitored PDCCH candidates and non-overlapped CCEs. The PDCCH monitoring capabilities can be different from the way to count the number of monitored PDCCH candidates and non-overlapped CCEs, and/or the maximum numbers of monitored PDCCH candidates and non-overlapped CCEs. Consequently, switching between first and second SSSG configuration results in the switching between PDCCH monitoring capabilities. Note: Type 1 CSS without dedicated RRC configuration and Type 0/0A/2 CSS may be monitored by the UE irrespective of the current active SSSG.

Various options to define multi-slot PDCCH monitoring capability can be considered. The three options may restrict the configuration of all SS sets. Alternatively, the three options may only restrict the configuration of a UE specific SS set, a Type3 CSS set and/or a Type 1 CSS set with dedicated RRC configuration. There can be no restriction for the configuration of other SS sets, or some other rules can apply to the configuration of other SS sets.

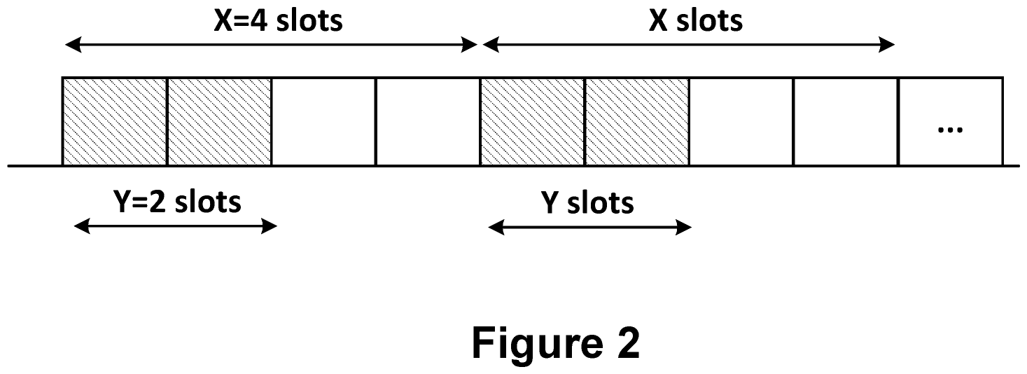

In a first option, a multi-slot PDCCH monitoring capability may support the configuration of PDCCH monitoring in Y consecutive slots, e.g. the first up to Y consecutive slots within every group of X consecutive slots, Y<X, Y≥1, as shown in FIG. 2. Alternatively, X and/or Y could be defined in number of symbols, e.g. Y can be up to 3 symbols, or Y can be larger than 3 symbols. The slot groups are consecutive and non-overlapping. The start of the first slot group in a subframe is aligned with the subframe boundary. This capability can be expressed as a combination of (X, Y) with X being the fixed size of slot group.

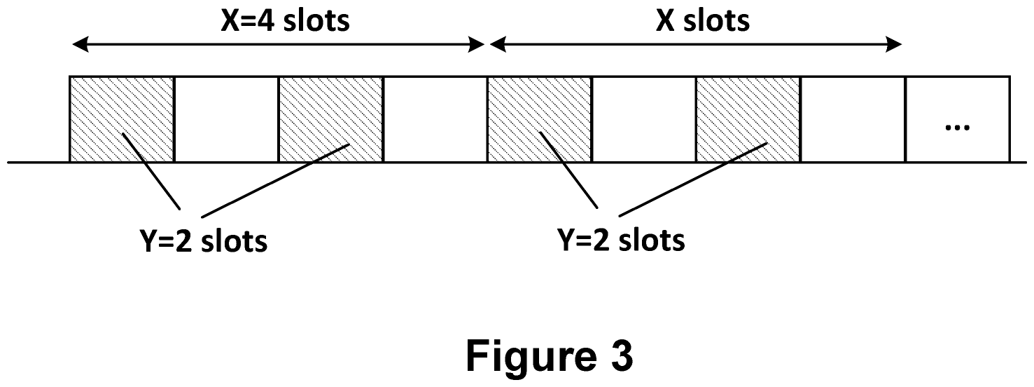

In a second option, a multi-slot PDCCH monitoring capability may support the configuration of PDCCH monitoring in only Y slots within every group of X consecutive slots, X>Y, Y≥1, as shown in FIG. 3. In this option, it is allowed that the Y slots is distributed in a group of X consecutive slots. Further, the Y slots may or may not be in same position in different groups. Alternatively, X and/or Y could be defined in number of symbols, e.g. Y can be up to 3 symbols, or Y can be larger than 3 symbols. This capability can be expressed as a combination of (X, Y) with X being the fixed size of slot group. Comparing with the first option on PDCCH monitoring capability, the complexity of PDCCH monitoring at UE side may be reduced, however, UE has to monitor PDCCHs frequently which is not good for power saving.

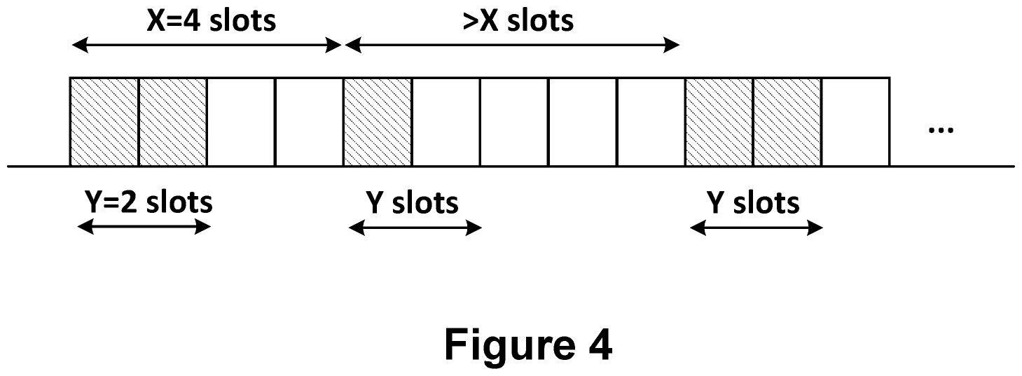

In a third option, a multi-slot PDCCH monitoring capability may support the configuration of PDCCH monitoring in a span of up to Y consecutive slots and the distance between two adjacent spans is at least X slots, X>Y, Y≥1, as shown in FIG. 4. The actual number and/or positions of the slots that are configured for PDCCH monitoring in different spans may be same or different Alternatively, the PDCCH MOs are configured in a span of Y consecutive symbols and X may also defined in number of symbols. For example, Y can be up to 3 symbols, or Y can be larger than 3 symbols. This capability can be expressed as a combination of (X, Y) with X being the minimum gap between two spans.

### Switching Between Capabilities Defined Per-Slot and Per Multiple Slots

The switching between the first and second SSSG configuration may result in switching between a PDCCH monitoring capability on maximum numbers of monitored PDCCH candidates and non-overlapped CCEs that is defined per slot, and another PDCCH monitoring capability on the corresponding maximum numbers that is defined in a group of slots, e.g. a multi-slot PDCCH monitoring capability combination (X, Y). For example, to allow fast DL transmission after LBT is successful, the first (default) SSSG configuration may provide frequent PDCCH monitoring in every slot, however, the numbers of monitored PDCCH candidates and non-overlapped CCEs in a slot are reduced, e.g. PDCCH monitoring capability per slot. On the other hand, the second SSSG configuration satisfies a second PDCCH monitoring capability defined in a group of slots. Assuming the group has X slots, the maximum numbers of monitored PDCCH candidates and non-overlapped CCEs of the second PDCCH monitoring capability may not be X times of the corresponding maximum numbers of the PDCCH monitoring capability per slot.

For the per slot PDCCH monitoring capability, it is expected that the maximum number of non-overlapped CCEs in a slot is not less than the maximum PDCCH aggregation level (AL) that can be configured in a PDCCH candidate in the slot.

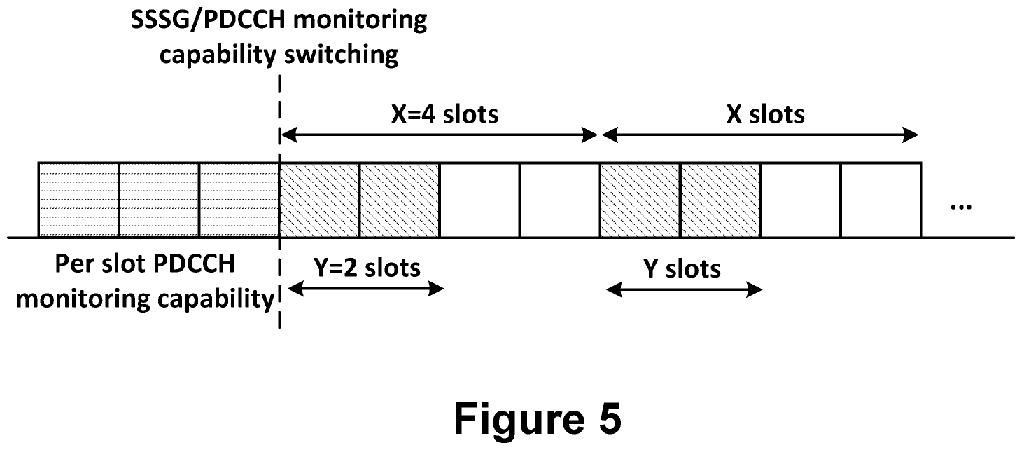

In one option, for the second SSSG, the associated PDCCH monitoring capability can use the first option of multi-slot PDCCH monitoring capability. FIG. 5 illustrates one example for the switching of SSSG configurations and the associated PDCCH monitoring capabilities, where for the second SSSG, the PDCCH monitoring is allowed in the two first slots in every 4 consecutive slots.

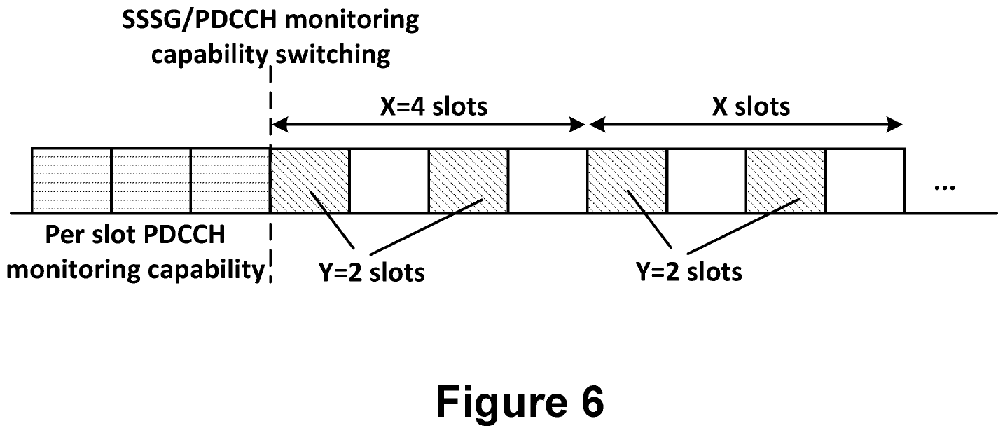

In another option, for the second SSSG, the associated PDCCH monitoring capability can use the second option of multi-slot PDCCH monitoring capability. FIG. 6 illustrates one example for the switching of SSSG configurations and the associated PDCCH monitoring capabilities, where for the second SSSG, the PDCCH monitoring is allowed in the first and third slots in every 4 consecutive slots.

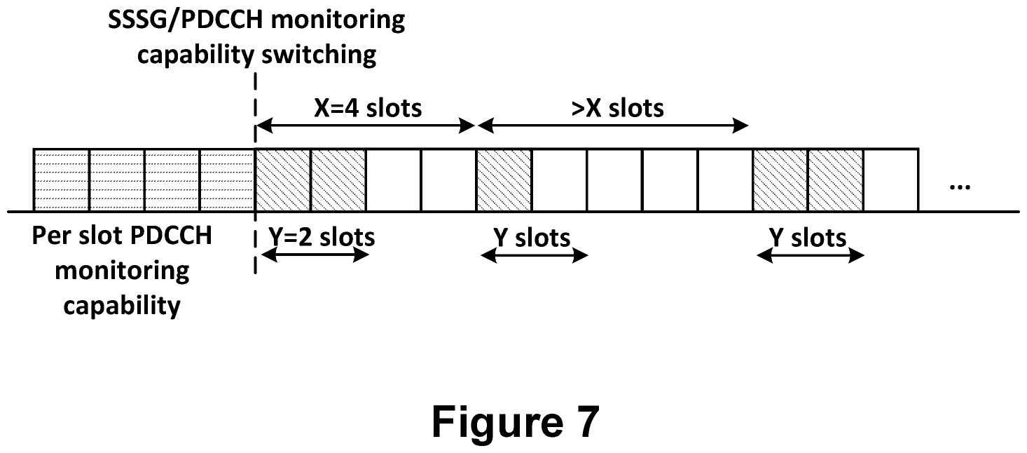

In another option, for the second SSSG, the associated PDCCH monitoring capability can use the third option of multi-slot PDCCH monitoring capability. FIG. 7 illustrates one example for the switching of SSSG configurations and the associated PDCCH monitoring capabilities, where for the second SSSG, the PDCCH monitoring defined with span of up to Y=2 slots and minimum distance X=4 slots.

### Switching Between Different Capabilities Defined Per Multiple Slots

The switching between the first and second SSSG configuration may result in switching between two different PDCCH monitoring capabilities on maximum numbers of monitored PDCCH candidates and non-overlapped CCEs and both two PDCCH monitoring capabilities are defined in in a group of slots, e.g. multi-slot PDCCH monitoring capability combinations (X1, Y1) and (X2, Y2). For example, to allow fast DL transmission after LBT is successful, the PDCCH monitoring capability for the first (default) SSSG configuration may provide more frequent PDCCH monitoring than the PDCCH monitoring capability for the second SSSG configuration, e.g., X1<X2. The maximum numbers of monitored PDCCH candidates and non-overlapped CCEs of the two PDCCH monitoring capabilities can be proportional to the group size of the two PDCCH monitoring capabilities. In another example, X₁=X₂, Y1 may be different from Y2. In this case, the maximum numbers of monitored PDCCH candidates and non-overlapped CCEs of the two combinations can be same. In another example, X₁=X₂, Y₁=Y₂ the position of the Y₁=Y₂ slot(s) in the X₁=X₂ slots for the multi-slot PDCCH monitoring capability can be different of the two SSSG configurations.

In one option, the two SSSG configurations may be associated with the above different options to define multi-slot PDCCH monitoring capabilities. In the case, the options to define the two PDCCH monitoring capabilities as well as the values of X and Y in the two PDCCH monitoring capabilities can be different.

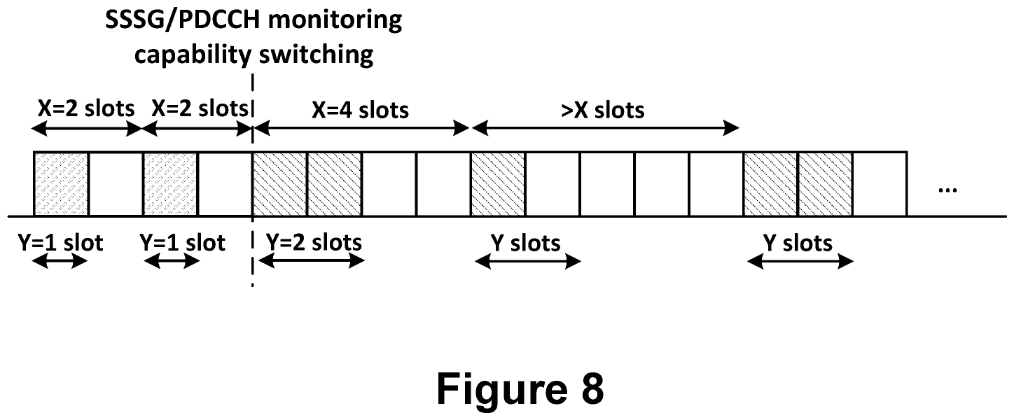

FIG. 8 illustrates one example for the switching of SSSG configurations and the associated different options of PDCCH monitoring capabilities. For the first SSSG, it uses the first option of multi-slot PDCCH monitoring capability. PDCCH monitoring is configured in the first Y=1 slot within every group of X=2 consecutive slots, which provides periodical and relative frequent PDCCH monitoring. On the other hand, for the second SSSG, it uses the third option of multi-slot PDCCH monitoring capability. The PDCCH monitoring is configured in a span of up to Y=2 consecutive slots and the distance between two adjacent spans is at least X=4 slots. The PDCCH monitoring of the second SSSG is less frequent which can be better in power saving. In another option, the two SSSG configurations may be associated with the above same option to define multi-slot PDCCH monitoring capability. However, the values of X and/or Y that are associated the two SSSG configurations can be different. In one example, same Y but different X, e.g., Y₁=Y₂, X₁≠X₂ can be configured for a first and second SSSG, respectively. In another example, same X but different Y, e.g., Y₁≠Y₂, X₁=X₂ can be configured for a first and second SSSG, respectively.

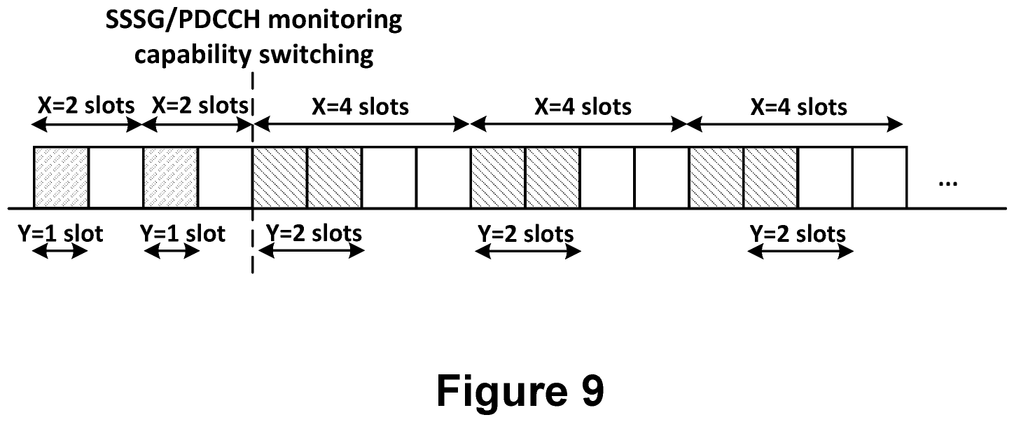

FIG. 9 illustrates one example for the switching of SSSG configurations that are associated with same option of PDCCH monitoring capability, e.g. PDCCH monitoring in the first Y consecutive slots within every group of X consecutive slots. For the first SSSG, Y=1 and X=2, which provides periodical and relative frequent PDCCH monitoring. On the other hand, for the second SSSG, Y=2 and X=4, which results in less frequent which can be better in power saving.

### Switching Between PDCCH Monitoring Capabilities

SSSG switching between a first SSSG and a second SSSG may be supported for the PDCCH monitoring of UE. It is assumed the first SSSG and the second SSSG are respectively associated with combination (X1, Y1) and (X2, Y2). Specifically, per-slot PDCCH monitoring capability, if applicable, can be viewed as a combination with X=Y=1. For example, the first SSSG is configured with frequent PDCCH monitoring occasions, while the second SSSG is configured with infrequent PDCCH monitoring occasions. Embodiments herein are not limited to the case that the first SSSG is configured with more frequent PDCCH monitoring than the second SSSG. UE needs a processing time, e.g. SSSG switching delay d₁₂ or d₂₁ to do SSSG switching, where, d₁₂ is the delay for the switching from the first SSSG to the second SSSG, d₂₁ is the delay for the switching from the second SSSG to the first SSSG. The delay d₁₂ and d₂₁ may be same or different.

For the case that X1 equals to X2, the SSSG switching delay d₁₂ and d₂₁ can be shorter than the case that X1 and X2 are different. d₁₂ and d₂₁ may be determined by the PDCCH decoding time, or d₁₂ and d₂₁ can be 0. In such case, Y1 may be different from Y2. Alternatively, Y₁=Y₂ however, the position of the Y₁=Y₂ slot(s) in the X₁=X₂ slots for the two SSSG configurations.

For the switching between per-slot PDCCH monitoring capability and multi-slot PDCCH monitoring capability, or between two different multi-slot PDCCH monitoring capabilities, the PDCCH monitoring according to the new SSSG may happen at the boundary of the first slot group of X slots of multi-slot PDCCH monitoring capability of the new SSSG that is after time t₀+d₁₂ or t₀+d₁₂. Alternatively, the PDCCH monitoring according to the new SSSG may happen at a first common boundary of a slot group of the first SSSG and a slot group of the second SSSG after time t₀+d₁₂ or t₀+d₁₂. Alternatively, the PDCCH monitoring according to the new SSSG may happen at first valid PDCCH MO of the new SSSG that is after time t₀+d₁₂ or t₀+d₁₂. Alternatively, the PDCCH monitoring according to the new SSSG may start from the first full slot that is after time t₀+d₁₂ or t₀+d₁₂. Alternatively, the PDCCH monitoring according to the new SSSG may start immediately from time t₀+d₁₂ or t₀+d₁₂.

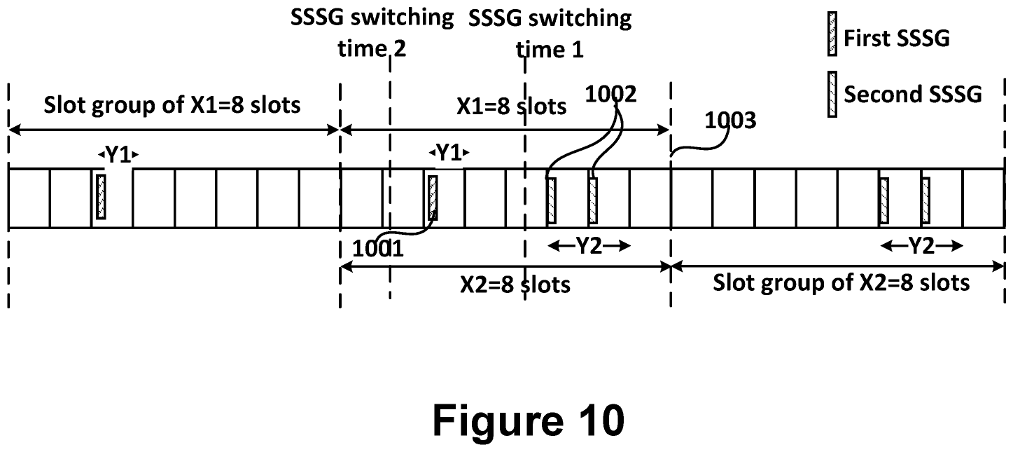

FIG. 10 illustrates one example of SSSG switching with value X1=X2=8 slots. FIG. 10 shows two possible SSSG switching time t₀+d₁₂. PDCCH monitoring according the second SSSG may happen after slot group boundary 1003. Alternatively, PDCCH monitoring according the second SSSG may happen right after a SSSG switching time t₀+d₁₂.
If PDCCH monitoring according the second SSSG may happen after slot group boundary 1003, UE may not monitor a PDCCH according to the first SSSG after the SSSG switching time. For example, UE doesn't do PDCCH monitoring 1001 if SSSG switching time 2 applies. On the other hand, UE can still do PDCCH monitoring 1001 if SSSG switching time 1 applies. Alternatively, UE doesn't do PDCCH monitoring 1101 irrespective of SSSG switching time 1 or 2. Alternatively, UE can still do PDCCH monitoring 1001 irrespective of SSSG switching time 1 or 2.
If PDCCH monitoring according the second SSSG may happen right after SSSG switching timet₀+d₁₂, it is possible for an early start of PDCCH monitoring 1002 according the second SSSG. UE doesn't do PDCCH monitoring 1001 according to the first SSSG. Alternatively, if a PDCCH monitoring occasion according to second SSSG doesn't exist after SSSG switching time and before boundary 1003, UE may still do PDCCH monitoring 1001, at least for the case that PDCCH monitoring 1001 is early than SSSG switching time 2. The UE does not monitor PDCCHs according to both SSSGs in a slot group of X1=X2=8 slots.

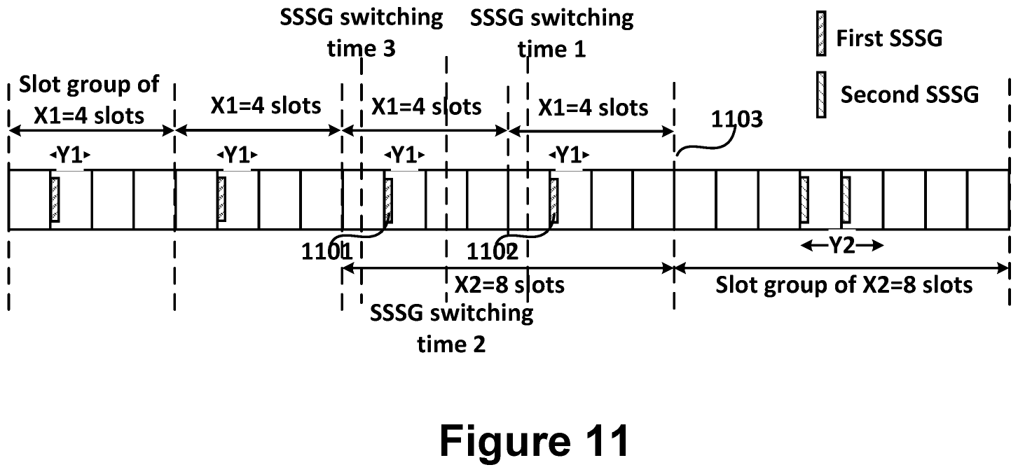

FIG. 11 illustrates one example of SSSG switching with value X1=4, X2=8 slots. FIG. 11 shows three possible SSSG switching time t₀+d₁₂. PDCCH monitoring according the second SSSG may happen after common slot group boundary 1103. Alternatively, PDCCH monitoring according the second SSSG may happen right after a SSSG switching time t₀+d₁₂.
If PDCCH monitoring according the second SSSG may happen after common slot group boundary 1103, UE may not monitor a PDCCH according to the first SSSG after the SSSG switching time. For example, if it is SSSG switching 1 or 2, UE may still do PDCCH monitoring 1101. Alternatively, if it is SSSG switching 1, UE can still do PDCCH monitoring 1101 since the slot group of the first SSSG containing 1101 is earlier than SSSG switching time 1. For SSSG switching time 2 or 3, both PDCCH monitoring 1101 and 1102 are canceled. Alternatively, both PDCCH monitoring 1101 and 1102 are canceled irrespective of SSSG switching time. Alternatively, UE can still do PDCCH monitoring 1101 and 1102 irrespective of SSSG switching time.

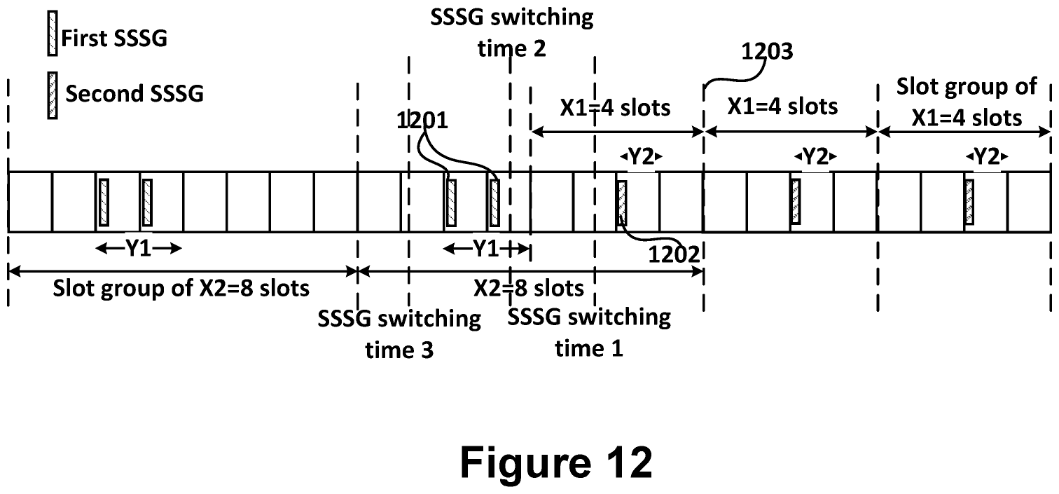

FIG. 12 illustrates one example of SSSG switching with value X1=8, X2=4 slots. FIG. 12 shows three possible SSSG switching time t₀+d₁₂. PDCCH monitoring according the second SSSG may happen after common slot group boundary 1203. Alternatively, PDCCH monitoring according the second SSSG may happen right after a SSSG switching time t₀+d₁₂.
If PDCCH monitoring according the second SSSG may happen after common slot group boundary 1203, for SSSG switching time 2 or 3, PDCCH monitoring 1202 is not applicable though it is in a slot group of the second SSSG after SSSG switching time. The UE may not monitor a PDCCH according to the first SSSG after the SSSG switching time. Alternatively, UE doesn't do PDCCH monitoring 1201 irrespective of SSSG switching time. Alternatively, UE can still do PDCCH monitoring 1201 irrespective of SSSG switching time.

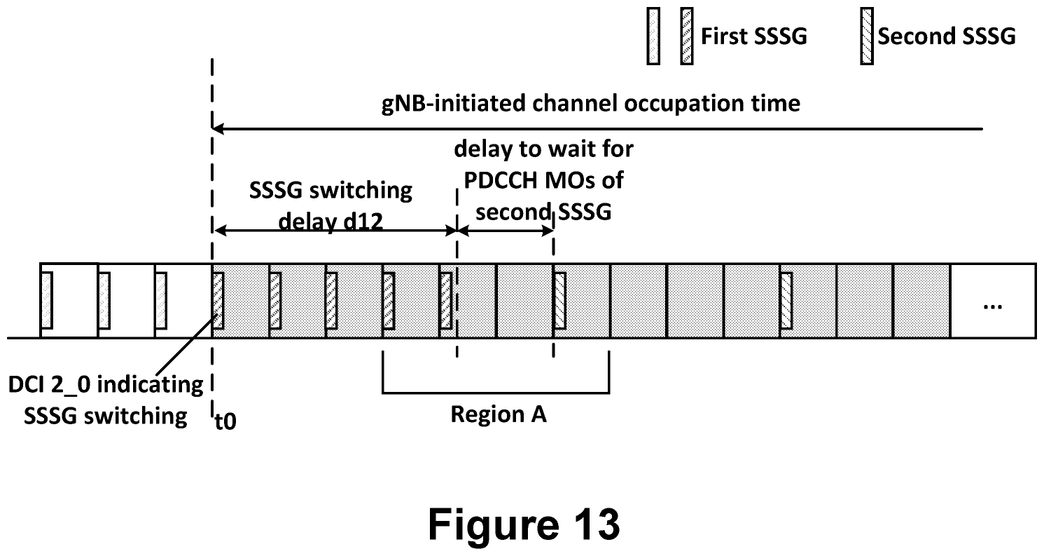

FIG. 13 illustrates one example for the switching from the first SSSG to the second SSSG. In this example, it is assumed that the periodicity for the search space set in the second SSSG is 4 slots. After detection of a DCI 2_0 which indicates SSSG switching, a switching delay d₁₂ is required to process PDCCH monitoring following the second SSSG. There can be an additional delay to wait for a valid PDCCH monitoring occasion of the second SSSG. Assuming X equals to 4 in the definition of PDCCH monitoring capability, as shown in FIG. 13, the pattern of PDCCH MOs is not allowed by PDCCH monitoring capability of the second SSSG in the region A. Further, the total number of blind detections equals to 2A+B in the region A which exceeds the capability B of the X-slot monitoring capability, where the per-slot PDCCH monitoring capability is A for the first SSSG and the X-slot PDCCH monitoring capability is B for the second SSSG.

In the following descriptions, for the first or second option of multi-slot PDCCH monitoring capability, a valid pattern means PDCCH MOs can be configured in the Y slots in a X-slot group. For the third option of multi-slot PDCCH monitoring capability, a valid pattern means X consecutive slots with a span of up to Y slots in the beginning of the X slots.

In the following embodiments, the restriction on PDCCH monitoring may apply to any SS set for a UE. Alternatively, it applies to all SS sets except for a SS set which is associated with both two SSSGs or not associated with any SSSG. Alternatively, it applies to all SS sets that are only monitored within the Y slots in the slot group of X slots.

In one embodiment, if the UE switches from the first SSSG to the second SSSG, the UE may not monitor PDCCHs in one or more slots or MOs that are immediately before time t₀+d₁₂, where, t₀ is the timing of the trigger for SSSG switching. The UE starts monitoring PDCCHs of the second SSSG from time t₀+d₁₂. An additional delay may be needed for the gNB to start scheduling DL and UL transmission using the second SSSG with PDCCH monitoring capability (X2, Y2). In this scheme, the complexity of PDCCH monitoring around the first valid MOs of the second SSSG is limited. The complexity can be controlled not exceeding the PDCCH monitoring capability of both two SSSGs. For example, the monitored PDCCH MOs immediately before the first valid MOs of the second SSSG can be a valid pattern according the multi-slot PDCCH monitoring capability of the second SSSG.

In one option, UE may not do PDCCH monitoring in the Z slots immediately before time t₀+d₁₂. Z is configured by high layer signaling or predefined. For example, Z could equal to X2, X2-1, X2-Y2, max(X₁, X₂) or max(X₁, X₂)−1.

In one option, UE may not do PDCCH monitoring in the 7 slots immediately before the first valid MOs of the second SSSG.

In another option, UE may not do PDCCH monitoring in the X-Y slots immediately before the first valid MOs of the second SSSG. For example, Z could equal to X2, X2-1, X2-Y2, max(X₁, X₂) or max(X₁, X₂)−1.

In another option, UE may not do PDCCH monitoring in the X2-Y2 slots immediately before the start of the valid pattern that contains the first valid MOs of the second SSSG.

In another option, UE may not do PDCCH monitoring in the Z slots immediately before the start boundary of first full slot group consisting of X2 slots after time t₀+d₁₂. Z is configured by high layer signaling or predefined. For example, Z could be X2, X2-1, X2-Y2, max(X₁, X₂) or max(X₁, X₂)−1.

In one embodiment, if UE switches from the first SSSG to the second SSSG, the UE may not monitor PDCCHs in one or more slots or MOs that are immediately after time t₀+d₁₂. In this scheme, the complexity of PDCCH monitoring around time t₀+d₁₂ can be controlled not exceeding the PDCCH monitoring capability of both two SSSGs.

In one option, in the Z slots that are immediately after time t₀+d₁₂, the UE may not monitor PDCCHs. Z is configured by high layer signaling or predefined. For example, Z could equal to X2, X2-1, X2-Y2, max(X₁, X₂) or max(X₁, X₂)−1.

In one option, in the Z slots that are immediately after the last valid MO of the first SSSG prior to time t₀+d₁₂, the UE may not monitor PDCCHs. Z is configured by high layer signaling or predefined. For example, Z could equal to X2, X2-1, X2-Y2, max(X₁, X₂) or max(X₁, X₂)−1.

In one option, in the Z slots immediately after the end of a last full slot group consisting of X1 slots prior to time t₀+d₁₂, the UE may not monitor PDCCHs. Z is configured by high layer signaling or predefined. For example, Z could equal to X2, X2-1, X2-Y2, max(X₁, X₂) or max(X₁, X₂)−1.

In one embodiment, if UE switches from the first SSSG to the second SSSG, in the Z slots that are immediately before time t₀+d₁₂, the UE may only monitor a SS set in the first SSSG that are configured in the slots that satisfy both combinations (X1, Y1) and (X2, Y2). The UE starts monitoring PDCCHs of the second SSSG from time t₀+d₁₂. Z can be configured by high layer signaling or predefined. For example, Z could be X2, X2-1, max(X₁, X₂) or max(X₁, X₂)−1. In this scheme, the complexity of PDCCH monitoring around time t₀+d₁₂ can be controlled not exceeding the PDCCH monitoring capability of both two SSSGs.

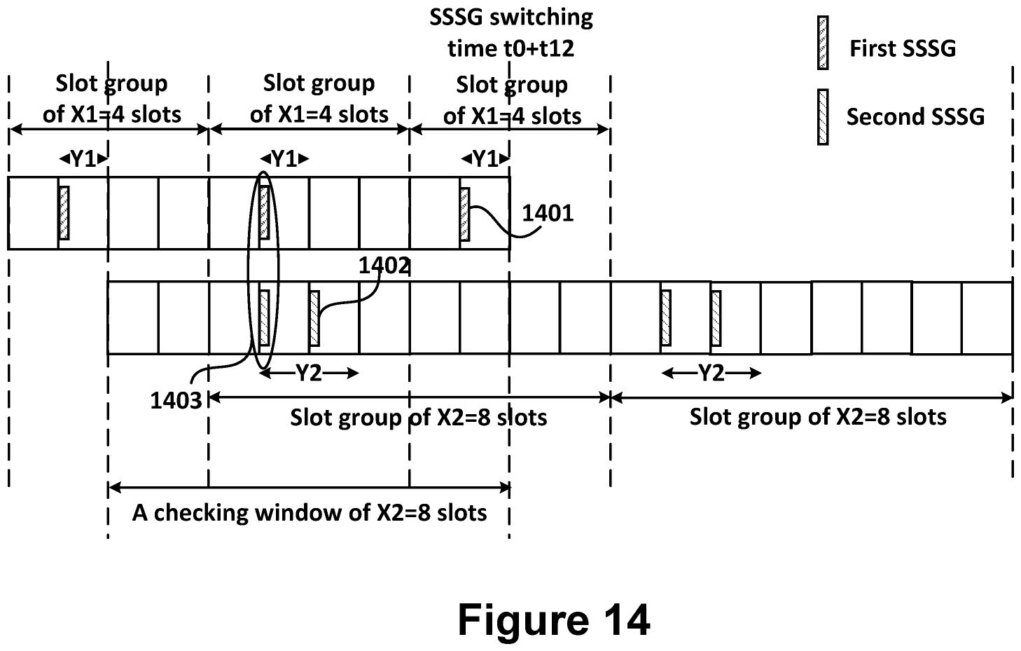

FIG. 14 illustrates one example of PDCCH monitoring when UE switches from the first SSSG to the second SSSG. It is assumed that the first SSSG and second SSSG uses combination (X1, Y1)=(4, 1) and (X2, Y2)=(8, 2). In the X2=8 slots before time t₀+d₁₂, which is the checking window in FIG. 14, the UE may only monitor a SS set in the first SSSG that are configured in the slots that satisfy both combination (4, 1) and (8, 2). Consequently, PDCCH MO 1401 is only allowed by combination (4, 1) and is not monitored by UE. PDCCH MO 1402 is only allowed by combination (8, 2) and is not monitored by UE. PDCCH MO 1403 is allowed by both combinations (4, 1) and (8,2), therefore, it can be monitored by UE.

In one embodiment, if UE switches from the first SSSG to the second SSSG, in the Z slots that are immediately after time t₀+d₁₂, the UE may only monitor a SS set in the second SSSG that are configured in the slots that satisfy both combinations (X1, Y1) and (X2, Y2). The UE starts monitoring PDCCHs of the second SSSG from time t₀+d₁₂. Z can be configured by high layer signaling or predefined. For example, Z could be X2, X2-1, max(X₁, X₂) or max(X₁, X₂)−1. In this scheme, the complexity of PDCCH monitoring around time t₀+d₁₂ can be controlled not exceeding the PDCCH monitoring capability of both two SSSGs.

In one embodiment, if the UE switches from the first SSSG to the second SSSG, in the Z slots that are immediately before the first valid MO of the second SSSG after time t₀+d₁₂, the UE may only monitor a SS set in the first SSSG that are configured in the slots that satisfy both combinations (X1, Y1) and (X2, Y2). The UE starts monitoring PDCCHs of the second SSSG from time t₀+d₁₂. Z can be configured by high layer signaling or predefined. For example, Z could be X2, X2-1, max(X₁, X₂) or max(X₁, X₂)−1. In this scheme, the complexity of PDCCH monitoring around time t₀+d₁₂ can be controlled not exceeding the PDCCH monitoring capability of both two SSSGs.

In one embodiment, if the UE switches from the first SSSG to the second SSSG, in a slot that is before the time t₀+d₁₂ and is within the Z slots before the first valid MO of the second SSSG after time t₀+d₁₂, the UE may only monitor a SS set in a slot in the first SSSG that are configured in a slot that satisfies both combinations (X1, Y1) and (X2, Y2). The UE starts monitoring PDCCHs of the second SSSG from time t₀+d₁₂. Z can be configured by high layer signaling or predefined. For example, Z could be X2, X2-1, max(X₁, X₂) or max(X₁, X₂)−1. In this scheme, the complexity of PDCCH monitoring around time t₀+d₁₂ can be controlled not exceeding the PDCCH monitoring capability of both two SSSGs.

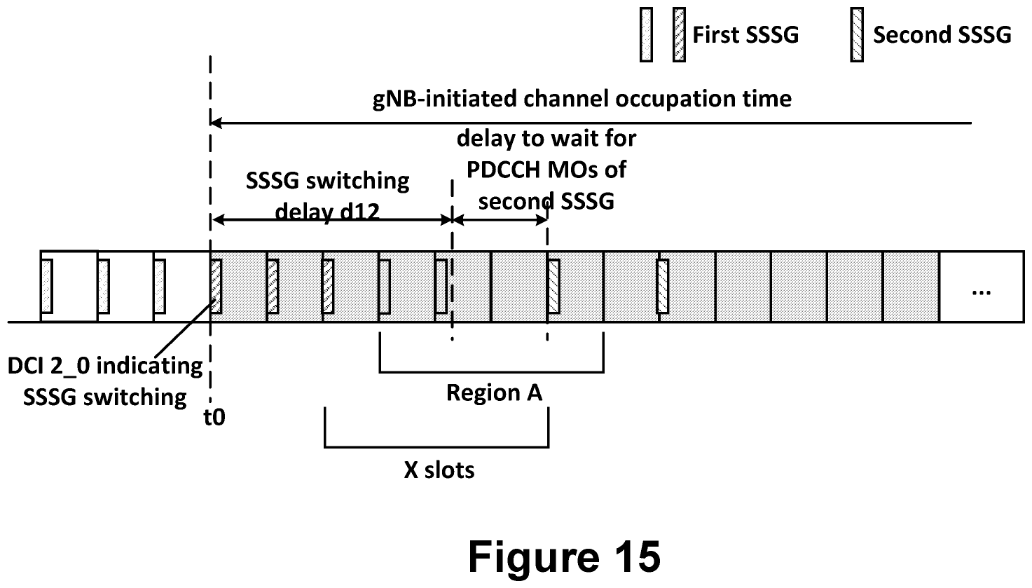

FIG. 15 illustrates one example of PDCCH monitoring according to the second SSSG before the first valid MO of the second SSSG when UE switches from the first SSSG to the second SSSG. It is assumed that per-slot PDCCH monitoring capability (X, Y)=(1, 1) is used for first SSSG and multi-slot PDCCH monitoring capability (X, Y)=(4, 1) applies to the second SSSG. The PDCCHs in the last two slots before time t₀+d₁₂ are not monitored according to the first SSSG. By this way, the pattern for PDCCH monitoring in region A is allowed by multi-slot PDCCH monitoring capability (4, 1). As shown in the X slots marked in FIG. 15, the minimum gap between the two spans is X=4 slots, or, it is a valid pattern within the slot group of X=4 slots. Note: In the X slot, the maximum numbers of monitored PDCCH candidates and non-overlapped CCEs in a slot with configured PDCCH MOs are still restricted by the monitoring capability of the first SSSG.

In one embodiment, if UE switches from the first SSSG to the second SSSG, in the Z slots that are immediately after the last valid MO of the first SSSG prior to time t₀+d₁₂, the UE may only monitor a SS set in the second SSSG that are configured in the slots that satisfies both combinations (X1, Y1) and (X2, Y2). The UE starts monitoring PDCCHs of the second SSSG from time t₀+d₁₂. Z can be configured by high layer signaling or predefined. For example, Z could be X2, X2-1, max(X₁, X₂) or max(X₁, X₂)−1. In this scheme, the complexity of PDCCH monitoring around time t₀+d₁₂ can be controlled not exceeding the PDCCH monitoring capability of both two SSSGs.

In one embodiment, if UE switches from the first SSSG to the second SSSG, in a slot that is after the time t₀+d₁₂ and is within the Z slots after the last valid MO of the first SSSG prior to time t₀+d₁₂, the UE may only monitor a SS set in a slot in the second SSSG that are configured in a slot that satisfies both combinations (X₁, Y1) and (X2, Y2). The UE starts monitoring PDCCHs of the second SSSG from time t₀+d₁₂. Z can be configured by high layer signaling or predefined. For example, Z could be X2, X2-1, max(X₁, X₂) or max(X₁, X₂)−1. In this scheme, the complexity of PDCCH monitoring around time t₀+d₁₂ can be controlled not exceeding the PDCCH monitoring capability of both two SSSGs.

In one embodiment, if UE switches from the first SSSG to the second SSSG, in the Z slots that are immediately before the start of a first full slot group of X2 slots after time t₀+d₁₂, the UE may only monitor a SS set in the first SSSG that are configured in the slots that satisfy both combinations (X1, Y1) and (X2, Y2). The UE starts monitoring PDCCHs of the second SSSG from time t₀+d₁₂. Z can be configured by high layer signaling or predefined. For example, Z could be X2, X2-1, max(X₁, X₂) or max(X₁, X₂)−1. In this scheme, the complexity of PDCCH monitoring around time t₀+d₁₂ can be controlled not exceeding the PDCCH monitoring capability of both two SSSGs.

In one embodiment, if the UE switches from the first SSSG to the second SSSG, in a slot that is before the time t₀+d₁₂ and is within the Z slots prior to the start of a first full slot group of X2 slots after time t₀+d₁₂, the UE may only monitor a SS set in the first SSSG that are configured in the slots that satisfy both combinations (X1, Y1) and (X2, Y2). The UE starts monitoring PDCCHs of the second SSSG from time t₀+d₁₂. Z can be configured by high layer signaling or predefined. For example, Z could be X2, X2-1, max(X₁, X₂) or max(X₁, X₂)−1. In this scheme, the complexity of PDCCH monitoring around time t₀+d₁₂ can be controlled not exceeding the PDCCH monitoring capability of both two SSSGs.

In one embodiment, if the UE switches from the first SSSG to the second SSSG, in a slot that is after the time t₀+d₁₂ and is within the Z slots after the end of a last full slot group of X1 slots prior to time t₀+d₁₂, the UE may only monitor a SS set in the second SSSG that are configured in the slots that satisfy both combinations (X1, Y1) and (X2, Y2). The UE starts monitoring PDCCHs of the second SSSG from time t₀+d₁₂. Z can be configured by high layer signaling or predefined. For example, Z could be X2, X2-1, max(X₁, X₂) or max(X₁, X₂)−1. In this scheme, the complexity of PDCCH monitoring around time t₀+d₁₂ can be controlled not exceeding the PDCCH monitoring capability of both two SSSGs.

In one embodiment, if the UE switches from the second SSSG to the first SSSG, the UE may not monitor PDCCHs belonging to the first SSSG in one or more slots that are immediately after time t₀+d₂₁, where, t₀ is the timing of the trigger for SSSG switching. In this scheme, the complexity of PDCCH monitoring around the last valid MOs of the second SSSG is limited. The complexity can be controlled not exceeding the PDCCH monitoring capability of the second SSSG. For example, the last valid MOs of the second SSSG and the monitored PDCCH MOs immediately after the last valid MOs of the second SSSG can be a valid pattern according the multi-slot PDCCH monitoring capability of the second SSSG. Therefore, the actual timing to do PDCCH monitoring with first SSSG is after the boundary of a valid pattern of the PDCCH monitoring capability of the second SSSG.

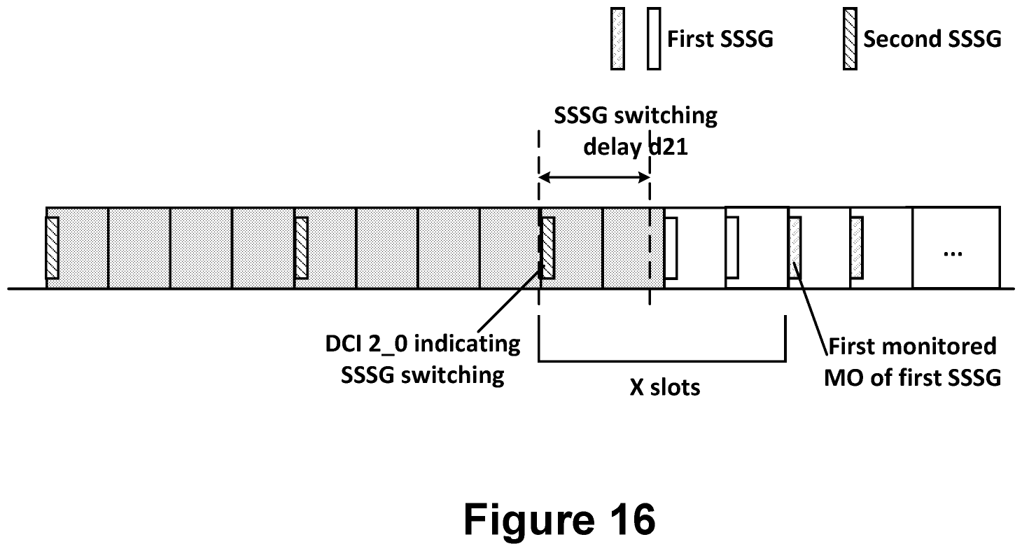

FIG. 16 illustrates one example of PDCCH monitoring according to the second SSSG after the last valid MO of the second SSSG for the switching from the second SSSG to the first SSSG. It is assumed that per-slot PDCCH monitoring capability is used for first SSSG and multi-slot PDCCH monitoring capability (X, Y)=(4, 1) applies to the second SSSG. The PDCCHs in the first two slots after time t₀+d 21 are not monitored according to the first SSSG. By this way, the pattern for PDCCH monitoring around the last MO of the second SSSG is allowed by multi-slot PDCCH monitoring capability (4, 1). As shown in the X slots marked in FIG. 16, the minimum gap between the two spans is X=4 slots, or, it is a valid pattern within the slot group of X=4 slots.

In one embodiment, for the case that X1 equals to X2, Y1 is different from Y2, the UE may expect that the same start slot of the Y1 slots and the Y2 slots in the slot group with X1=X2 slots for the first SSSG with combination (X1, Y1) and the second SSSG with combination (X2, Y2). Alternatively, UE may expect that the Y1 slots are a subset of the Y2 slots or the Y2 slots are a subset of the Y1 slots. In this case, UE may switch between the two SSSGs with a small switching delay, or without any switching delay, e.g. d₁₂ and d₂₁ are 0. Further, UE may not cancel any PDCCH MOs in any slot for the reason of SSSG switching.

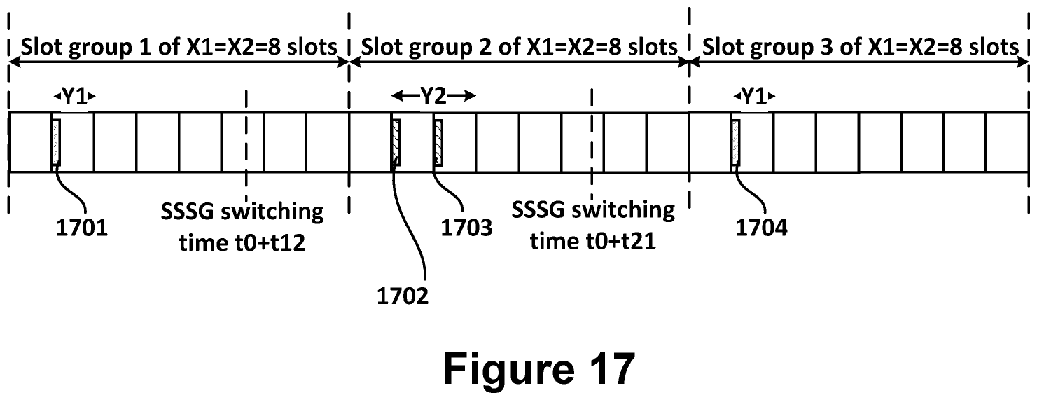

FIG. 17 illustrates one example where the two SSSGs are associated with combinations with same value X and same start slot of the Y1 slots and the Y2 slots in a slot group of X1=X2=X slots. Though there is switching from first SSSG to second SSSG in slot group 1, and there is also switching from the second SSSG to the first SSSG in slot group 2, PDCCH monitoring at UE side is not impacted. That is, UE an detect the PDCCHs in MOs 1701, 1702, 1703 and 1704 without any cancelation.

### Systems and Implementations

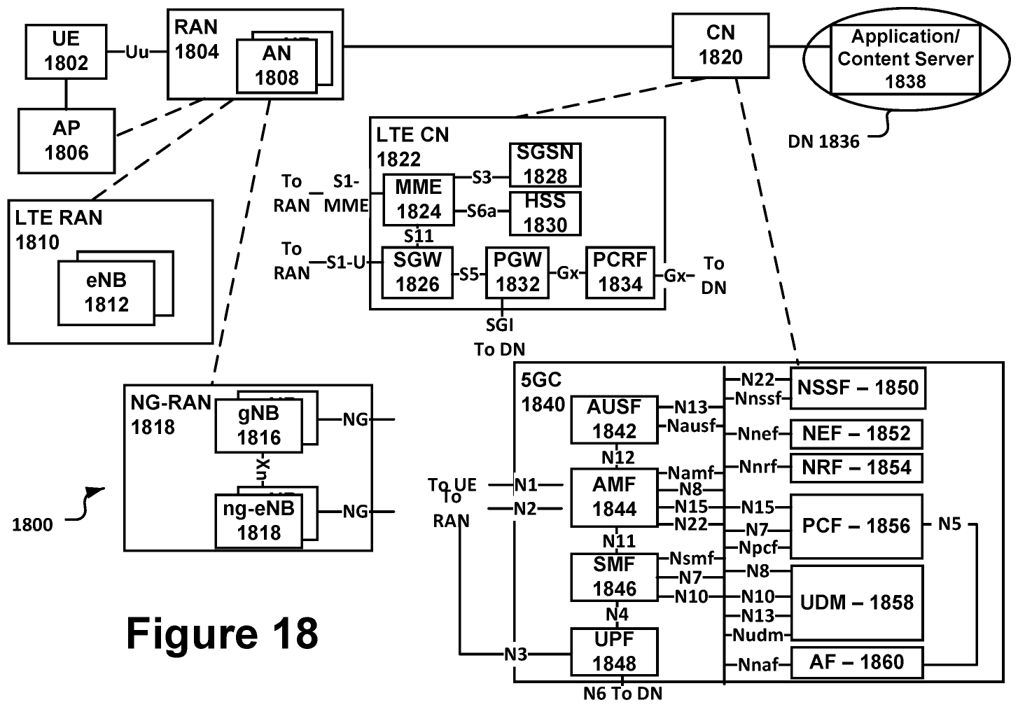

FIGS. 18-20 illustrate various systems, devices, and components that may implement aspects of disclosed embodiments.

FIG. 18 illustrates a network 1800 in accordance with various embodiments. The network 1800 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1800 may include a UE 1802, which may include any mobile or non-mobile computing device designed to communicate with a RAN 1804 via an over-the-air connection. The UE 1802 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1800 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1802 may additionally communicate with an AP 1806 via an over-the-air connection. The AP 1806 may manage a WLAN connection, which may serve to offload some/all network traffic from the RAN 1804. The connection between the UE 1802 and the AP 1806 may be consistent with any IEEE 802.11 protocol, wherein the AP 1806 could be a wireless fidelity (Wi-Fi®) router. In some embodiments, the UE 1802, RAN 1804, and AP 1806 may utilize cellular-WLAN aggregation (for example, LWA/LWIP). Cellular-WLAN aggregation may involve the UE 1802 being configured by the RAN 1804 to utilize both cellular radio resources and WLAN resources.

The RAN 1804 may include one or more access nodes, for example, AN 1808. AN 1808 may terminate air-interface protocols for the UE 1802 by providing access stratum protocols including RRC, PDCP, RLC, MAC, and L1 protocols. In this manner, the AN 1808 may enable data/voice connectivity between CN 1820 and the UE 1802. In some embodiments, the AN 1808 may be implemented in a discrete device or as one or more software entities running on server computers as part of, for example, a virtual network, which may be referred to as a CRAN or virtual baseband unit pool. The AN 1808 be referred to as a BS, gNB, RAN node, eNB, ng-eNB, NodeB, RSU, TRxP, TRP, etc. The AN 1808 may be a macrocell base station or a low power base station for providing femtocells, picocells or other like cells having smaller coverage areas, smaller user capacity, or higher bandwidth compared to macrocells.

In embodiments in which the RAN 1804 includes a plurality of ANs, they may be coupled with one another via an X2 interface (if the RAN 1804 is an LTE RAN) or an Xn interface (if the RAN 1804 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1804 may each manage one or more cells, cell groups, component carriers, etc. to provide the UE 1802 with an air interface for network access. The UE 1802 may be simultaneously connected with a plurality of cells provided by the same or different ANs of the RAN 1804. For example, the UE 1802 and RAN 1804 may use carrier aggregation to allow the UE 1802 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1804 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1802 or AN 1808 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1804 may be an LTE RAN 1810 with eNBs, for example, eNB 1812. The LTE RAN 1810 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1804 may be an NG-RAN 1814 with gNBs, for example, gNB 1816, or ng-eNBs, for example, ng-eNB 1818. The gNB 1816 may connect with 5G-enabled UEs using a 5G NR interface. The gNB 1816 may connect with a 5G core through an NG interface, which may include an N2 interface or an N3 interface. The ng-eNB 1818 may also connect with the 5G core through an NG interface, but may connect with a UE via an LTE air interface. The gNB 1816 and the ng-eNB 1818 may connect with each other over an Xn interface.

In some embodiments, the NG interface may be split into two parts, an NG user plane (NG-U) interface, which carries traffic data between the nodes of the NG-RAN 1814 and a UPF 1848 (e.g., N3 interface), and an NG control plane (NG-C) interface, which is a signaling interface between the nodes of the NG-RAN1814 and an AMF 1844 (e.g., N2 interface).

The NG-RAN 1814 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1802 can be configured with multiple BWPs where each BWP configuration has a different SCS. When a BWP change is indicated to the UE 1802, the SCS of the transmission is changed as well. Another use case example of BWP is related to power saving. In particular, multiple BWPs can be configured for the UE 1802 with different amount of frequency resources (for example, PRBs) to support data transmission under different traffic loading scenarios. A BWP containing a smaller number of PRBs can be used for data transmission with small traffic load while allowing power saving at the UE 1802 and in some cases at the gNB 1816. A BWP containing a larger number of PRBs can be used for scenarios with higher traffic load.

The RAN 1804 is communicatively coupled to CN 1820 that includes network elements to provide various functions to support data and telecommunications services to customers/subscribers (for example, users of UE 1802). The components of the CN 1820 may be implemented in one physical node or separate physical nodes. In some embodiments, NFV may be utilized to virtualize any or all of the functions provided by the network elements of the CN 1820 onto physical compute/storage resources in servers, switches, etc. A logical instantiation of the CN 1820 may be referred to as a network slice, and a logical instantiation of a portion of the CN 1820 may be referred to as a network sub-slice.

In some embodiments, the CN 1820 may be an LTE CN 1822, which may also be referred to as an EPC. The LTE CN 1822 may include MME 1824, SGW 1826, SGSN 1828, HSS 1830, PGW 1832, and PCRF 1834 coupled with one another over interfaces (or “reference points”) as shown. Functions of the elements of the LTE CN 1822 may be briefly introduced as follows.

The MME 1824 may implement mobility management functions to track a current location of the UE 1802 to facilitate paging, bearer activation/deactivation, handovers, gateway selection, authentication, etc.

The SGW 1826 may terminate an S1 interface toward the RAN and route data packets between the RAN and the LTE CN 1822. The SGW 1826 may be a local mobility anchor point for inter-RAN node handovers and also may provide an anchor for inter-3GPP mobility. Other responsibilities may include lawful intercept, charging, and some policy enforcement.

The SGSN 1828 may track a location of the UE 1802 and perform security functions and access control. In addition, the SGSN 1828 may perform inter-EPC node signaling for mobility between different RAT networks; PDN and S-GW selection as specified by MME 1824; MME selection for handovers; etc. The S3 reference point between the MME 1824 and the SGSN 1828 may enable user and bearer information exchange for inter-3GPP access network mobility in idle/active states.

The HSS 1830 may include a database for network users, including subscription-related information to support the network entities' handling of communication sessions. The HSS 1830 can provide support for routing/roaming, authentication, authorization, naming/addressing resolution, location dependencies, etc. An Sha reference point between the HSS 1830 and the MME 1824 may enable transfer of subscription and authentication data for authenticating/authorizing user access to the LTE CN 1820.

The PGW 1832 may terminate an SGi interface toward a data network (DN) 1836 that may include an application/content server 1838. The PGW 1832 may route data packets between the LTE CN 1822 and the data network 1836. The PGW 1832 may be coupled with the SGW 1826 by an S5 reference point to facilitate user plane tunneling and tunnel management. The PGW 1832 may further include a node for policy enforcement and charging data collection (for example, PCEF). Additionally, the SGi reference point between the PGW 1832 and the data network 18 36 may be an operator external public, a private PDN, or an intra-operator packet data network, for example, for provision of IMS services. The PGW 1832 may be coupled with a PCRF 1834 via a Gx reference point.

The PCRF 1834 is the policy and charging control element of the LTE CN 1822. The PCRF 1834 may be communicatively coupled to the app/content server 1838 to determine appropriate QoS and charging parameters for service flows. The PCRF 1832 may provision associated rules into a PCEF (via Gx reference point) with appropriate TFT and QCI.

In some embodiments, the CN 1820 may be a 5GC 1840. The 5GC 1840 may include an AUSF 1842, AMF 1844, SMF 1846, UPF 1848, NSSF 1850, NEF 1852, NRF 1854, PCF 1856, UDM 1858, and AF 1860 coupled with one another over interfaces (or “reference points”) as shown. Functions of the elements of the 5GC 1840 may be briefly introduced as follows.

The AUSF 1842 may store data for authentication of UE 1802 and handle authentication-related functionality. The AUSF 1842 may facilitate a common authentication framework for various access types. In addition to communicating with other elements of the 5GC 1840 over reference points as shown, the AUSF 1842 may exhibit an Nausf service-based interface.

The AMF 1844 may allow other functions of the 5GC 1840 to communicate with the UE 1802 and the RAN 1804 and to subscribe to notifications about mobility events with respect to the UE 1802. The AMF 1844 may be responsible for registration management (for example, for registering UE 1802), connection management, reachability management, mobility management, lawful interception of AMF-related events, and access authentication and authorization. The AMF 1844 may provide transport for SM messages between the UE 1802 and the SMF 1846, and act as a transparent proxy for routing SM messages. AMF 1844 may also provide transport for SMS messages between UE 1802 and an SMSF. AMF 1844 may interact with the AUSF 1842 and the UE 1802 to perform various security anchor and context management functions. Furthermore, AMF 1844 may be a termination point of a RAN CP interface, which may include or be an N2 reference point between the RAN 1804 and the AMF 1844; and the AMF 1844 may be a termination point of NAS (N1) signaling, and perform NAS ciphering and integrity protection. AMF 1844 may also support NAS signaling with the UE 1802 over an N3 IWF interface.

The SMF 1846 may be responsible for SM (for example, session establishment, tunnel management between UPF 1848 and AN 1808); UE IP address allocation and management (including optional authorization); selection and control of UP function; configuring traffic steering at UPF 1848 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1844 over N2 to AN 1808; and determining SSC mode of a session. SM may refer to management of a PDU session, and a PDU session or “session” may refer to a PDU connectivity service that provides or enables the exchange of PDUs between the UE 1802 and the data network 1836.

The UPF 1848 may act as an anchor point for intra-RAT and inter-RAT mobility, an external PDU session point of interconnect to data network 1836, and a branching point to support multi-homed PDU session. The UPF 1848 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1848 may include an uplink classifier to support routing traffic flows to a data network.

The NSSF 1850 may select a set of network slice instances serving the UE 1802. The NSSF 1850 may also determine allowed NSSAI and the mapping to the subscribed S-NSSAIs, if needed. The NSSF 1850 may also determine the AMF set to be used to serve the UE 1802, or a list of candidate AMFs based on a suitable configuration and possibly by querying the NRF 1854. The selection of a set of network slice instances for the UE 1802 may be triggered by the AMF 1844 with which the UE 1802 is registered by interacting with the NS SF 1850, which may lead to a change of AMF. The NSSF 1850 may interact with the AMF 1844 via an N22 reference point; and may communicate with another NSSF in a visited network via an N31 reference point (not shown). Additionally, the NSSF 1850 may exhibit an Nnssf service-based interface.

The NEF 1852 may securely expose services and capabilities provided by 3GPP network functions for third party, internal exposure/re-exposure, AFs (e.g., AF 1860), edge computing or fog computing systems, etc. In such embodiments, the NEF 1852 may authenticate, authorize, or throttle the AFs. NEF 1852 may also translate information exchanged with the AF 1860 and information exchanged with internal network functions. For example, the NEF 1852 may translate between an AF-Service-Identifier and an internal 5GC information. NEF 1852 may also receive information from other NFs based on exposed capabilities of other NFs. This information may be stored at the NEF 1852 as structured data, or at a data storage NF using standardized interfaces. The stored information can then be re-exposed by the NEF 1852 to other NFs and AFs, or used for other purposes such as analytics. Additionally, the NEF 1852 may exhibit an Nnef service-based interface.

The NRF 1854 may support service discovery functions, receive NF discovery requests from NF instances, and provide the information of the discovered NF instances to the NF instances. NRF 1854 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1854 may exhibit the Nnrf service-based interface.

The PCF 1856 may provide policy rules to control plane functions to enforce them, and may also support unified policy framework to govern network behavior. The PCF 1856 may also implement a front end to access subscription information relevant for policy decisions in a UDR of the UDM 1858. In addition to communicating with functions over reference points as shown, the PCF 1856 exhibit an Npcf service-based interface.

The UDM 1858 may handle subscription-related information to support the network entities' handling of communication sessions, and may store subscription data of UE 1802. For example, subscription data may be communicated via an N8 reference point between the UDM 1858 and the AMF 1844. The UDM 1858 may include two parts, an application front end and a UDR. The UDR may store subscription data and policy data for the UDM 1858 and the PCF 1856, and/or structured data for exposure and application data (including PFDs for application detection, application request information for multiple UEs 1802) for the NEF 1852. The Nudr service-based interface may be exhibited by the UDR 221 to allow the UDM 1858, PCF 1856, and NEF 1852 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1858 may exhibit the Nudm service-based interface.

The AF 1860 may provide application influence on traffic routing, provide access to NEF, and interact with the policy framework for policy control.

In some embodiments, the 5GC 1840 may enable edge computing by selecting operator/3^{rd} party services to be geographically close to a point that the UE 1802 is attached to the network. This may reduce latency and load on the network. To provide edge-computing implementations, the 5GC 1840 may select a UPF 1848 close to the UE 1802 and execute traffic steering from the UPF 1848 to data network 1836 via the N6 interface. This may be based on the UE subscription data, UE location, and information provided by the AF 1860. In this way, the AF 1860 may influence UPF (re)selection and traffic routing. Based on operator deployment, when AF 1860 is considered to be a trusted entity, the network operator may permit AF 1860 to interact directly with relevant NFs. Additionally, the AF 1860 may exhibit an Naf service-based interface.

The data network 1836 may represent various network operator services, Internet access, or third party services that may be provided by one or more servers including, for example, application/content server 1838.

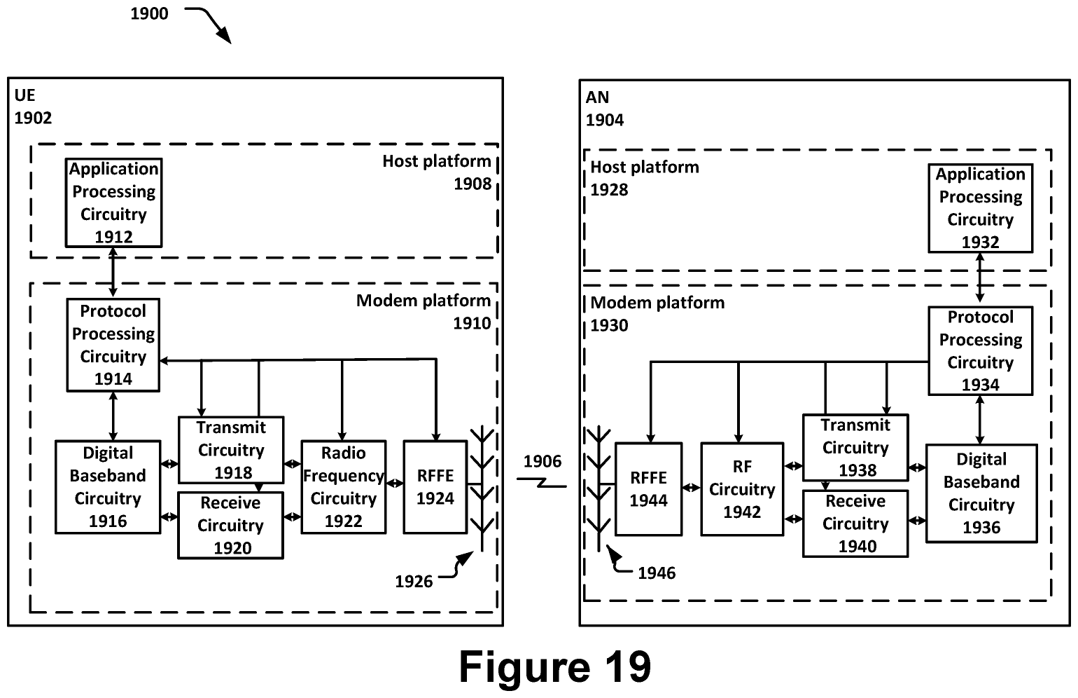

FIG. 19 schematically illustrates a wireless network 1900 in accordance with various embodiments. The wireless network 1900 may include a UE 1902 in wireless communication with an AN 1904. The UE 1902 and AN 1904 may be similar to, and substantially interchangeable with, like-named components described elsewhere herein.

The UE 1902 may be communicatively coupled with the AN 1904 via connection 1906. The connection 1906 is illustrated as an air interface to enable communicative coupling, and can be consistent with cellular communications protocols such as an LTE protocol or a 5G NR protocol operating at mmWave or sub-6 GHz frequencies.

The UE 1902 may include a host platform 1908 coupled with a modem platform 1910. The host platform 1908 may include application processing circuitry 1912, which may be coupled with protocol processing circuitry 1914 of the modem platform 1910. The application processing circuitry 1912 may run various applications for the UE 1902 that source/sink application data. The application processing circuitry 1912 may further implement one or more layer operations to transmit/receive application data to/from a data network. These layer operations may include transport (for example UDP) and Internet (for example, IP) operations

The protocol processing circuitry 1914 may implement one or more of layer operations to facilitate transmission or reception of data over the connection 1906. The layer operations implemented by the protocol processing circuitry 1914 may include, for example, MAC, RLC, PDCP, RRC and NAS operations.

The modem platform 1910 may further include digital baseband circuitry 1916 that may implement one or more layer operations that are “below” layer operations performed by the protocol processing circuitry 1914 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1910 may further include transmit circuitry 1918, receive circuitry 1920, RF circuitry 1922, and RF front end (RFFE) 1924, which may include or connect to one or more antenna panels 1926. Briefly, the transmit circuitry 1918 may include a digital-to-analog converter, mixer, intermediate frequency (IF) components, etc.; the receive circuitry 1920 may include an analog-to-digital converter, mixer, IF components, etc.; the RF circuitry 1922 may include a low-noise amplifier, a power amplifier, power tracking components, etc.; RFFE 1924 may include filters (for example, surface/bulk acoustic wave filters), switches, antenna tuners, beamforming components (for example, phase-array antenna components), etc. The selection and arrangement of the components of the transmit circuitry 1918, receive circuitry 1920, RF circuitry 1922, RFFE 1924, and antenna panels 1926 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1914 may include one or more instances of control circuitry (not shown) to provide control functions for the transmit/receive components.

A UE reception may be established by and via the antenna panels 1926, RFFE 1924, RF circuitry 1922, receive circuitry 1920, digital baseband circuitry 1916, and protocol processing circuitry 1914. In some embodiments, the antenna panels 1926 may receive a transmission from the AN 1904 by receive-beamforming signals received by a plurality of antennas/antenna elements of the one or more antenna panels 1926.

A UE transmission may be established by and via the protocol processing circuitry 1914, digital baseband circuitry 1916, transmit circuitry 1918, RF circuitry 1922, RFFE 1924, and antenna panels 1926. In some embodiments, the transmit components of the UE 1904 may apply a spatial filter to the data to be transmitted to form a transmit beam emitted by the antenna elements of the antenna panels 1926.

Similar to the UE 1902, the AN 1904 may include a host platform 1928 coupled with a modem platform 1930. The host platform 1928 may include application processing circuitry 1932 coupled with protocol processing circuitry 1934 of the modem platform 1930. The modem platform may further include digital baseband circuitry 1936, transmit circuitry 1938, receive circuitry 1940, RF circuitry 1942, RFFE circuitry 1944, and antenna panels 1946. The components of the AN 1904 may be similar to and substantially interchangeable with like-named components of the UE 1902. In addition to performing data transmission/reception as described above, the components of the AN 1908 may perform various logical functions that include, for example, RNC functions such as radio bearer management, uplink and downlink dynamic radio resource management, and data packet scheduling.

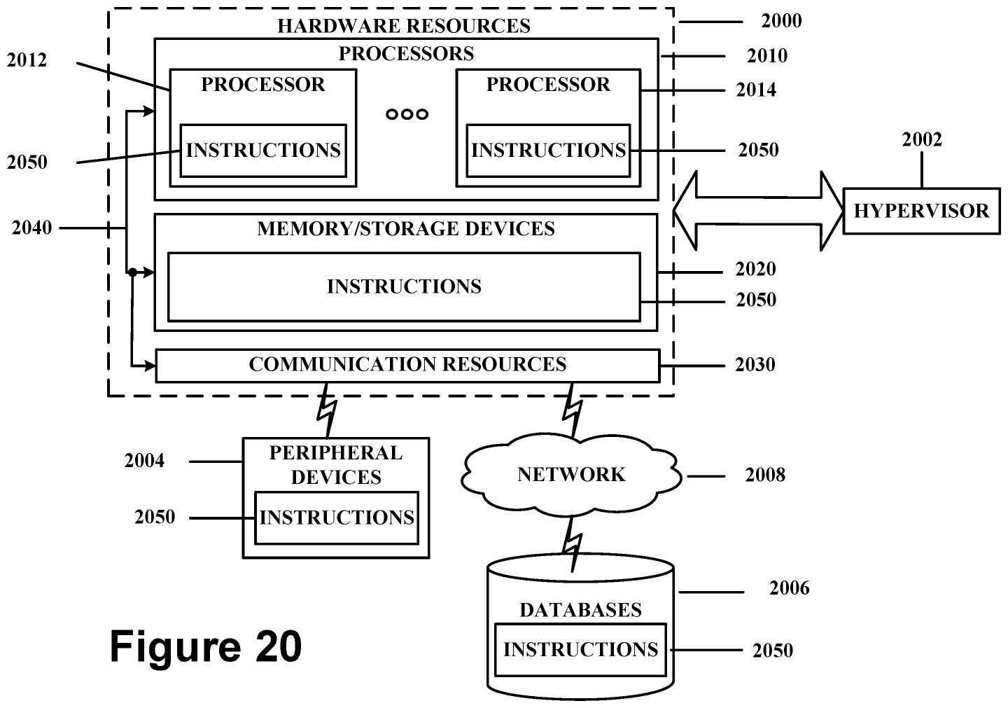

FIG. 20 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 20 shows a diagrammatic representation of hardware resources 2000 including one or more processors (or processor cores) 2010, one or more memory/storage devices 2020, and one or more communication resources 2030, each of which may be communicatively coupled via a bus 2040 or other interface circuitry. For embodiments where node virtualization (e.g., NFV) is utilized, a hypervisor 2002 may be executed to provide an execution environment for one or more network slices/sub-slices to utilize the hardware resources 2000.

The processors 2010 may include, for example, a processor 2012 and a processor 2014. The processors 2010 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 2020 may include main memory, disk storage, or any suitable combination thereof. The memory/storage devices 2020 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 2030 may include interconnection or network interface controllers, components, or other suitable devices to communicate with one or more peripheral devices 2004 or one or more databases 2006 or other network elements via a network 2008. For example, the communication resources 2030 may include wired communication components (e.g., for coupling via USB, Ethernet, etc.), cellular communication components, NFC components, Bluetooth® (or Bluetooth® Low Energy) components, Wi-Fi® components, and other communication components.

Instructions 2050 may comprise software, a program, an application, an applet, an app, or other executable code for causing at least any of the processors 2010 to perform any one or more of the methodologies discussed herein. The instructions 2050 may reside, completely or partially, within at least one of the processors 2010 (e.g., within the processor's cache memory), the memory/storage devices 2020, or any suitable combination thereof. Furthermore, any portion of the instructions 2050 may be transferred to the hardware resources 2000 from any combination of the peripheral devices 2004 or the databases 2006. Accordingly, the memory of processors 2010, the memory/storage devices 2020, the peripheral devices 2004, and the databases 2006 are examples of computer-readable and machine-readable media.

### Example Procedures

In some embodiments, the electronic device(s), network(s), system(s), chip(s) or component(s), or portions or implementations thereof, of FIGS. 18-20, or some other FIG. herein, may be configured to perform one or more processes, techniques, or methods as described herein, or portions thereof.

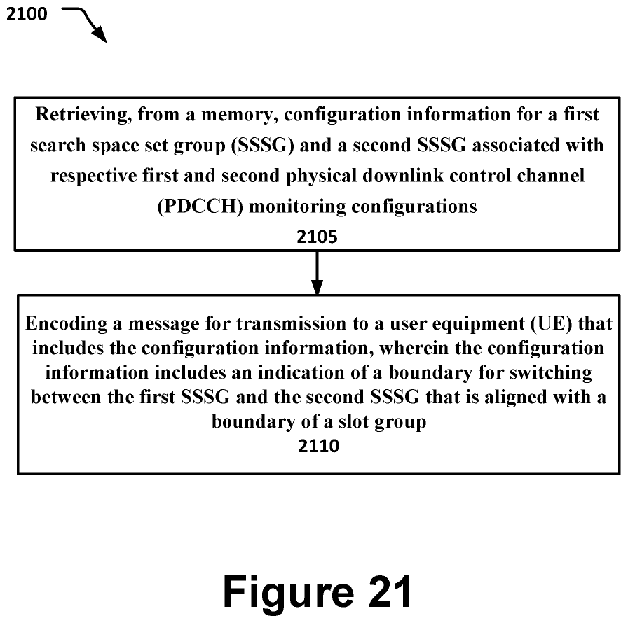

One such process is depicted in FIG. 21. For example, the process may include, at 2105 retrieving, from a memory, configuration information for a first search space set group (SSSG) and a second SSSG associated with respective first and second physical downlink control channel (PDCCH) monitoring configurations. The process further includes, at 2110, encoding a message for transmission to a user equipment (UE) that includes the configuration information, wherein the configuration information includes an indication of a boundary for switching between the first SSSG and the second SSSG that is aligned with a boundary of a slot group.

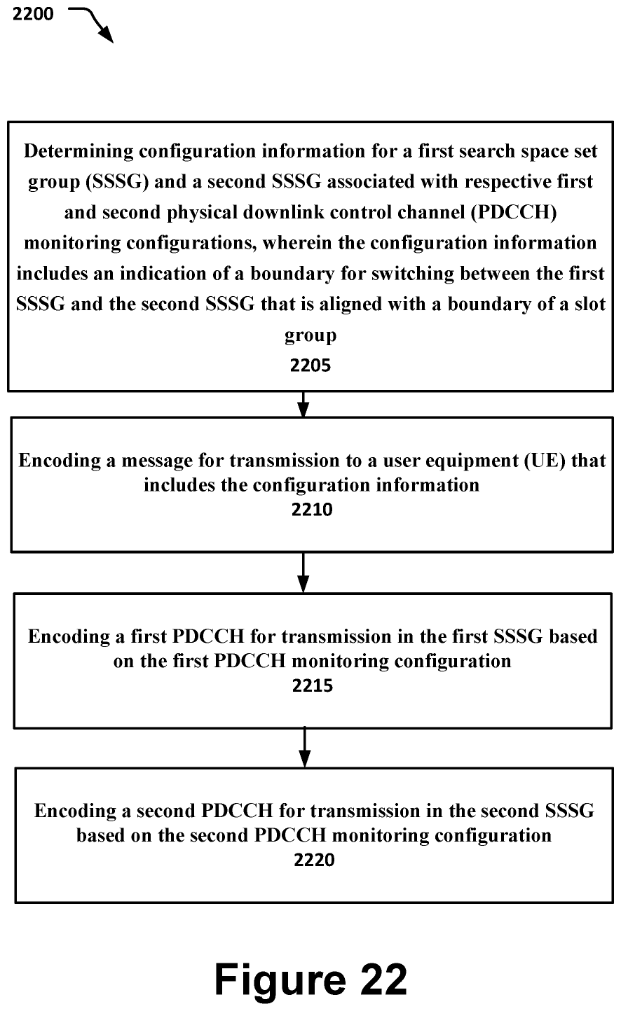

FIG. 22 illustrates another process in accordance with various embodiments. In this example, process 2200 includes, at 2205, determining configuration information for a first search space set group (SSSG) and a second SSSG associated with respective first and second physical downlink control channel (PDCCH) monitoring configurations, wherein the configuration information includes an indication of a boundary for switching between the first SSSG and the second SSSG that is aligned with a boundary of a slot group. The process further includes, at 2210, encoding a message for transmission to a user equipment (UE) that includes the configuration information. The process further includes, at 2215, encoding a first PDCCH for transmission in the first SSSG based on the first PDCCH monitoring configuration. The process further includes, at 2220, encoding a second PDCCH for transmission in the second SSSG based on the second PDCCH monitoring configuration.

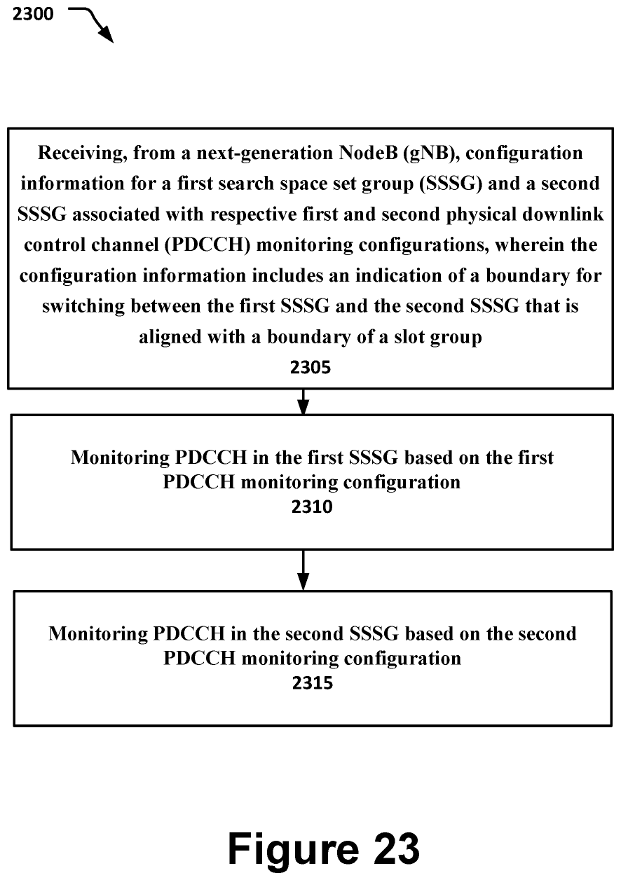

FIG. 23 illustrates another process in accordance with various embodiments. In this example, process 2300 includes, at 2305, receiving, from a next-generation NodeB (gNB), configuration information for a first search space set group (SSSG) and a second SSSG associated with respective first and second physical downlink control channel (PDCCH) monitoring configurations, wherein the configuration information includes an indication of a boundary for switching between the first SSSG and the second SSSG that is aligned with a boundary of a slot group. The process further includes, at 2310, monitoring PDCCH in the first SSSG based on the first PDCCH monitoring configuration. The process further includes, at 2315, monitoring PDCCH in the second SSSG based on the second PDCCH monitoring configuration.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example 1 may include a method of wireless communication for the switching of PDCCH monitoring configurations, the method comprising:
receiving, by a UE, the high layer configuration on the search space sets and two search space set group (SSSG)s; and
decoding, by the UE, a DCI from physical downlink control channel (PDCCH) in a SSSG using a PDCCH monitoring capability.

Example 2 may include the method of example 1 or some other example herein, wherein the two SSSG configurations are associated with different PDCCH monitoring capabilities.

Example 3 may include the method of example 2 or some other example herein, wherein the PDCCH monitoring capabilities are different from the way to count the number of monitored PDCCH candidates and non-overlapped CCEs, and/or the maximum numbers of monitored PDCCH candidates and non-overlapped CCEs.

Example 4 may include the method of example 2 or some other example herein, switching between first and second SSSG configuration results in the switching between PDCCH monitoring capabilities.

Example 5 may include the method of example 4 or some other example herein, wherein the switching is between a PDCCH monitoring capability defined per slot, and another PDCCH monitoring capability defined in a group of slots.

Example 6 may include the method of example 4 or some other example herein, wherein the switching is between two different PDCCH monitoring capabilities defined in in a group of slots.

Example 7 may include the method of example 6 or some other example herein, wherein the way to define the two PDCCH monitoring capabilities and/or the values of X and Y in the two PDCCH monitoring capabilities are different.

Example 8 may include the method of example 6 or some other example herein, wherein the values of X and/or Y of the PDCCH monitoring capabilities that are associated the two SSSG configurations are different

Example 9 may include the method of examples 2-8 or some other example herein, wherein a PDCCH monitoring capability supports the configuration of PDCCH monitoring in the first up to Y consecutive slots within every group of X consecutive slots.

Example 10 may include the method of examples 2-8 or some other example herein, wherein a PDCCH monitoring capability supports the configuration of PDCCH monitoring in only up to Y slots within every group of X consecutive slots.

Example 11 may include the method of examples 2-8 or some other example herein, wherein a PDCCH monitoring capability supports the configuration of PDCCH monitoring in a span of up to Y consecutive slots and the distance between two adjacent spans is at least X slots.

Example 12 may include the method of example 2 or some other example herein, wherein if UE switches from the first SSSG to the second SSSG, the UE doesn't monitor PDCCHs in one or more slots or MOs that are immediately before time t₀+d₁₂, where, t₀ is the timing of the trigger for SSSG switching, d₁₂ is the delay for the switching from the first SSSG to the second SSSG.

Example 13 may include the method of example 2 or some other example herein, wherein if UE switches from the first SSSG to the second SSSG, the UE doesn't monitor PDCCHs in one or more slots or MOs that are immediately after time t₀+d₁₂.

Example 14 may include the method of example 2 or some other example herein, wherein if UE switches from the first SSSG to the second SSSG, in the one or more slots that are immediately before time t₀+d₁₂, the UE may only monitor a SS set in the first SSSG that are configured in the slots that satisfy both combinations (X, Y) of the two SSSGs.

Example 15 may include the method of example 2 or some other example herein, wherein if UE switches from the first SSSG to the second SSSG, in the one or more slots that are immediately after time t₀+d₁₂, the UE may only monitor a SS set in the second SSSG that are configured in the slots that satisfy both combinations (X, Y) of the two SSSGs.

Example 16 may include the method of example 2 or some other example herein, wherein for the case that X1 equals to X2, Y1 is different from Y2, the UE expect that the same start slot of the Y1 slots and the Y2 slots in the slot group, where the two SSSGs respectively associate with combination (X1, Y1) and (X2, Y2), UE does not cancel any PDCCH MOs in any slot.

Example 17 may include the method of example 2 or some other example herein, wherein if UE switches from the second SSSG to the first SSSG, the UE may not monitor PDCCHs belonging to the first SSSG in one or more slots that are immediately after time t₀+d₂₁, where, t₀ is the timing of the trigger for SSSG switching, d₂₁ is the delay for the switching from the second SSSG to the first SSSG.

Example 18 may include a method of a user equipment (UE), the method comprising:
receiving configuration information for a first search space set group (SSSG) and a second SSSG;
monitoring for a physical downlink control channel (PDCCH) in the first SSSG based on a first PDCCH monitoring configuration; and
monitoring for a PDCCH in the second SSSG based on a second PDCCH monitoring configuration.

Example 19 may include the method of example 18 or some other example herein, wherein the first and second SSSGs are in unlicensed spectrum.

Example 20 may include the method of example 18-19 or some other example herein, wherein the UE is to switch from the first SSSG to the second SSSG at a start of a gNB-initiated channel occupation time (COT).

Example 21 may include the method of example 18-21 or some other example herein, wherein the first PDCCH monitoring configuration includes PDCCH monitoring occasions in every slot.

Example 22 may include the method of example 18-21 or some other example herein, wherein at least one of the first or second PDCCH monitoring configuration includes PDCCH monitoring occasions in a subset of slots of the second SSSG.

Example 23 may include the method of example 22 or some other example herein, wherein at least one of the first or second PDCCH monitoring configuration includes PDCCH monitoring occasions in up to the first Y consecutive slots for respective groups of X consecutive slots.

Example 24 may include the method of example 22 or some other example herein, wherein at least one of the first or second PDCCH monitoring configuration includes PDCCH monitoring occasions in up to Y slots (e.g., consecutive or non-consecutive) for respective groups of X consecutive slots.

Example 25 may include the method of example 22 or some other example herein, wherein at least one of the first or second PDCCH monitoring configurations includes PDCCH monitoring occasions in a span of up to Y consecutive slots and a distance between two adjacent spans of at least X slots.

Example 26 may include the method of example 23-24 or some other example herein, wherein Y is 2 and X is 4.

Example 27 may include the method of example 19-22 or some other example herein, wherein the values of X and/or Y are different for the first and second PDCCH monitoring configuration.

Example 28 may include the method of example 18-27 or some other example herein, wherein the first and second PDCCH monitoring configurations are associated with different PDCCH monitoring capabilities.

Example 29 may include the method of example 28 or some other example herein, wherein the first PDCCH monitoring configuration is up to a maximum number of monitoring occasions or non-overlapped CCEs per slot, and the second PDCCH monitoring configuration is up to a maximum number of monitoring occasions or non-overlapped CCEs per group of multiple slots.

Example 30 may include the method of example 18-29 or some other example herein, further comprising:
switching from monitoring the first SSSG to monitoring the second SSSG; and
determining not to monitor for a PDCCH associated with the first SSSG in one or more slots or MOs that are immediately before time t₀+d₁₂, wherein t₀ is a timing of the trigger for SSSG switching, and d₁₂ is a delay for the switching from the first SSSG to the second SSSG.

Example 31 may include the method of example 18-30 or some other example herein, further comprising:
switching from monitoring the first SSSG to monitoring the second SSSG; and
determining not to monitor for a PDCCH associated with the first SSSG in one or more slots that are immediately after time t₀+d₂₁, wherein t₀ is a timing of the trigger for SSSG switching, and d₂₁ is a delay for the switching from the second SSSG to the first SSSG.

Example 32 may include a method of a next generation Node B (gNB), the method comprising:
encoding, for transmission to a user equipment (UE), configuration information for a first search space set group (SSSG) and a second SSSG associated with respective first and second physical downlink control channel (PDCCH) monitoring configurations;
encoding a first PDCCH for transmission in the first SSSG based on the first PDCCH monitoring configuration; and
encoding a second PDCCH for transmission in the second SSSG based on the second PDCCH monitoring configuration.

Example 33 may include the method of example 32 or some other example herein, wherein the first and second SSSGs are in unlicensed spectrum.

Example 34 may include the method of example 32-33 or some other example herein, further comprising switching from the first SSSG to the second SSSG at a start of a gNB-initiated channel occupation time (COT).

Example 35 may include the method of example 32-34 or some other example herein, wherein the first PDCCH monitoring configuration includes PDCCH monitoring occasions in every slot.

Example 36 may include the method of example 32-34 or some other example herein, wherein at least one of the first or second PDCCH monitoring configuration includes PDCCH monitoring occasions in a subset of slots of the second SSSG.

Example 37 may include the method of example 36 or some other example herein, wherein at least one of the first or second PDCCH monitoring configuration includes PDCCH monitoring occasions in up to the first Y consecutive slots for respective groups of X consecutive slots.

Example 38 may include the method of example 36 or some other example herein, wherein at least one of the first or second PDCCH monitoring configuration includes PDCCH monitoring occasions in up to Y slots (e.g., consecutive or non-consecutive) for respective groups of X consecutive slots.

Example 39 may include the method of example 36 or some other example herein, wherein at least one of the first or second PDCCH monitoring configurations includes PDCCH monitoring occasions in a span of up to Y consecutive slots and a distance between two adjacent spans of at least X slots.

Example 40 may include the method of example 37-39 or some other example herein, wherein Y is 2 and X is 4.

Example 41 may include the method of example 37-40 or some other example herein, wherein the values of X and/or Y are different for the first and second PDCCH monitoring configuration.

Example 42 may include the method of example 32-41 or some other example herein, wherein the first and second PDCCH monitoring configurations are associated with different PDCCH monitoring capabilities.

Example 43 may include the method of example 42 or some other example herein, wherein the first PDCCH monitoring configuration is up to a maximum number of monitoring occasions or non-overlapped CCEs per slot, and the second PDCCH monitoring configuration is up to a maximum number of monitoring occasions or non-overlapped CCEs per group of multiple slots.

Example 44 may include the method of example 42-43 or some other example herein, further comprising:
triggering the UE to switch from monitoring the first SSSG to monitoring the second SSSG; and
determining not to send a PDCCH associated with the first SSSG to the UE in one or more slots or MOs that are immediately before time t₀+d₁₂, wherein t₀ is a timing of the trigger for SSSG switching, and d₁₂ is a delay for the switching from the first SSSG to the second SSSG.

Example 45 may include the method of example 32-44 or some other example herein, further comprising:
triggering the UE to switch from monitoring the first SSSG to monitoring the second SSSG; and
determining not to send a PDCCH associated with the first SSSG to the UE in one or more slots that are immediately after time t₀+d₂₁, wherein t₀ is a timing of the trigger for SSSG switching, and d₂₁ is a delay for the switching from the second SSSG to the first SSSG.

Example X1 includes an apparatus comprising:
memory to store configuration information for a first search space set group (SSSG) and a second SSSG associated with respective first and second physical downlink control channel (PDCCH) monitoring configurations; and
processing circuitry, coupled with the memory, to:
   retrieve the configuration information from the memory; and
   encode a message for transmission to a user equipment (UE) that includes the configuration information, wherein the configuration information includes an indication of a boundary for switching between the first SSSG and the second SSSG that is aligned with a boundary of a slot group.

Example X2 includes the apparatus of example X1 or some other example herein, wherein the processing circuitry is further to:
encode a first PDCCH for transmission in the first SSSG based on the first PDCCH monitoring configuration; and
encode a second PDCCH for transmission in the second SSSG based on the second PDCCH monitoring configuration.

Example X3 includes the apparatus of example X1 or some other example herein, wherein one or more of the first PDCCH monitoring configuration and the second PDCCH monitoring configuration includes respective PDCCH monitoring occasions in up to Y consecutive slots within respective slot groups of X consecutive slots.

Example X4 includes the apparatus of example X3 or some other example herein, wherein the first PDCCH monitoring configuration and second PDDCH monitoring configuration include: a common value for X but a different value for Y, or a common value for Y but a different value for X, or a different value for Y and a different value for X.

Example X5 includes the apparatus of example X3 or some other example herein, wherein:
Z slots around the boundary for switching between the first SSSG and the second SSSG are empty without PDCCH monitoring; or
Z slots around the boundary for switching between the first SSSG and the second SSSG are to include PDCCH monitoring based on respective values for X and Y in the first PDCCH monitoring configuration and second PDDCH monitoring configuration.

Example X6 includes the apparatus of example X1 or some other example herein, wherein the switching between the first SSSG and second SSSG includes switching between two different PDCCH monitoring capabilities for a maximum number of monitored PDCCH candidates and non-overlapped control channel elements (CCEs).

Example X7 includes the apparatus of any of examples X1-X6 or some other example herein, wherein the slot groups are consecutive and non-overlapping.

Example X8 includes the apparatus of any of examples X1-X7 or some other example herein, wherein a start of a first slot group in a subframe is aligned with a boundary of the subframe.

Example X9 includes one or more computer-readable media storing instructions that, when executed by one or more processors, cause a next-generation NodeB (gNB) to:
determine configuration information for a first search space set group (SSSG) and a second SSSG associated with respective first and second physical downlink control channel (PDCCH) monitoring configurations, wherein the configuration information includes an indication of a boundary for switching between the first SSSG and the second SSSG that is aligned with a boundary of a slot group;
encode a message for transmission to a user equipment (UE) that includes the configuration information;
encode a first PDCCH for transmission in the first SSSG based on the first PDCCH monitoring configuration; and
encode a second PDCCH for transmission in the second SSSG based on the second PDCCH monitoring configuration.

Example X10 includes the one or more computer readable media of example X9 or some other example herein, wherein one or more of the first PDCCH monitoring configuration and the second PDCCH monitoring configuration includes respective PDCCH monitoring occasions in up to Y consecutive slots within respective slot groups of X consecutive slots.

Example X11 includes the one or more computer readable media of example X10 or some other example herein, wherein the first PDCCH monitoring configuration and second PDDCH monitoring configuration include: a common value for X but a different value for Y, or a common value for Y but a different value for X, or a different value for Y and a different value for X.

Example X12 includes the one or more computer readable media of example X10 or some other example herein, wherein:
Z slots around the boundary for switching between the first SSSG and the second SSSG are empty without PDCCH monitoring; or
Z slots around the boundary for switching between the first SSSG and the second SSSG are to include PDCCH monitoring based on respective values for X and Y in the first PDCCH monitoring configuration and second PDDCH monitoring configuration.

Example X13 includes the one or more computer readable media of example X9 or some other example herein, wherein the switching between the first SSSG and second SSSG includes switching between two different PDCCH monitoring capabilities for a maximum number of monitored PDCCH candidates and non-overlapped control channel elements (CCEs).

Example X14 includes the one or more computer readable media of any of examples X9-X13, wherein the slot groups are consecutive and non-overlapping.

Example X15 includes the one or more computer readable media of any of examples X9-X14, wherein a start of a first slot group in a subframe is aligned with a boundary of the subframe.

Example X16 includes one or more computer-readable media storing instructions that, when executed by one or more processors, cause a user equipment (UE) to:
receive, from a next-generation NodeB (gNB), configuration information for a first search space set group (SSSG) and a second SSSG associated with respective first and second physical downlink control channel (PDCCH) monitoring configurations, wherein the configuration information includes an indication of a boundary for switching between the first SSSG and the second SSSG that is aligned with a boundary of a slot group;
monitor PDCCH in the first SSSG based on the first PDCCH monitoring configuration; and
monitor PDCCH in the second SSSG based on the second PDCCH monitoring configuration.

Example X17 includes the one or more computer readable media of example X16 or some other example herein, wherein one or more of the first PDCCH monitoring configuration and the second PDCCH monitoring configuration includes respective PDCCH monitoring occasions in up to Y consecutive slots within respective slot groups of X consecutive slots.

Example X18 includes the one or more computer readable media of example X17 or some other example herein, wherein the first PDCCH monitoring configuration and second PDDCH monitoring configuration include: a common value for X but a different value for Y, or a common value for Y but a different value for X, or a different value for Y and a different value for X.

Example X19 includes the one or more computer readable media of example X17 or some other example herein, wherein:
Z slots around the boundary for switching between the first SSSG and the second SSSG are empty without PDCCH monitoring; or
Z slots around the boundary for switching between the first SSSG and the second SSSG are to include PDCCH monitoring based on respective values for X and Y in the first PDCCH monitoring configuration and second PDDCH monitoring configuration.

Example X20 includes the one or more computer readable media of example X16 or some other example herein, wherein the switching between the first SSSG and second SSSG includes switching between two different PDCCH monitoring capabilities for a maximum number of monitored PDCCH candidates and non-overlapped control channel elements (CCEs).

Example X21 includes the one or more computer readable media of any of examples X16-X20 or some other example herein, wherein the slot groups are consecutive and non-overlapping.

Example X22 includes the one or more computer readable media of any of examples X16-X21 or some other example herein, wherein a start of a first slot group in a subframe is aligned with a boundary of the subframe.

Example Z01 may include an apparatus comprising means to perform one or more elements of a method described in or related to any of examples 1-X22, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-X22, or any other method or process described herein.

Example Z03 may include an apparatus comprising logic, modules, or circuitry to perform one or more elements of a method described in or related to any of examples 1-X22, or any other method or process described herein.

Example Z04 may include a method, technique, or process as described in or related to any of examples 1-X22, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-X22, or portions thereof.

Example Z06 may include a signal as described in or related to any of examples 1-X22, or portions or parts thereof.

Example Z07 may include a datagram, packet, frame, segment, protocol data unit (PDU), or message as described in or related to any of examples 1-X22, or portions or parts thereof, or otherwise described in the present disclosure.

Example Z08 may include a signal encoded with data as described in or related to any of examples 1-X22, or portions or parts thereof, or otherwise described in the present disclosure.

Example Z09 may include a signal encoded with a datagram, packet, frame, segment, protocol data unit (PDU), or message as described in or related to any of examples 1-X22, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-X22, or portions thereof.

Example Z11 may include a computer program comprising instructions, wherein execution of the program by a processing element is to cause the processing element to carry out the method, techniques, or process as described in or related to any of examples 1-X22, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

3GPP Third
Generation
Partnership
Project
4G Fourth
Generation
5G Fifth
Generation
5GC 5G Core
network
AC
Application
Client
ACK
Acknowledgement
ACID
Application
Client Identification
AF Application
Function
AM Acknowledged
Mode
AMBRAggregate
Maximum Bit Rate
AMF Access and
Mobility
Management
Function
AN Access
Network
ANR Automatic
Neighbour Relation
AP Application
Protocol, Antenna
Port, Access Point
API Application
Programming Interface
APN Access Point
Name
ARP Allocation and
Retention Priority
ARQ Automatic
Repeat Request
AS Access Stratum
ASP
Application Service
Provider
ASN.1 Abstract Syntax
Notation One
AUSF Authentication
Server Function
AWGN Additive
White Gaussian
Noise
BAP Backhaul
Adaptation Protocol
BCH Broadcast
Channel
BER Bit Error Ratio
BFD Beam
Failure Detection
BLER Block Error
Rate
BPSK Binary Phase
Shift Keying
BRAS Broadband
Remote Access
Server
BSS Business
Support System
BS Base Station
BSR Butter Status
Report
BW Bandwidth
BWP Bandwidth Part
C-RNTI Cell
Radio Network
Temporary
Identity
CA Carrier
Aggregation,
Certification
Authority
CAPEX CAPital
EXpenditure
CBRA Contention
Based Random
Access
CC Component
Carrier, Country
Code, Cryptographic
Checksum
CCA Clear Channel
Assessment
CCE Control
Channel Element
CCCH Common
Control Channel
CE Coverage
Enhancement
CDM Content
Delivery Network
CDMA Code-
Division Multiple
Access
CFRA Contention Free
Random Access
CG Cell Group
CGF Charging
Gateway Function
CHF Charging
Function
CI Cell Identity
CID Cell-ID (e.g.,
positioning method)
CIM Common
Information Model
CIR Carrier to
Interference Ratio
CK Cipher Key
CM Connection
Management,
Conditional
Mandatory
CMAS Commercial
Mobile Alert Service
CMD Command
CMS Cloud
Management System
CO Conditional
Optional
CoMP Coordinated
Multi-Point
CORESET Control
Resource Set
COTS Commercial
Off-The-Shelf
CP Control Plane,
Cyclic Prefix,
Connection
Point
CPD Connection
Point Descriptor
CPE Customer
Premise
Equipment
CPICHCommon Pilot
Channel
CQI Channel
Quality Indicator
CPU CSI processing
unit, Central
Processing Unit
C/R
Command/
Response field bit
CRAN Cloud Radio
Access
Network, Cloud
RAN
CRB Common
Resource Block
CRC Cyclic
Redundancy Check
CRI Channel-State
Information
Resource
Indicator, CSI-RS
Resource
Indicator
C-RNTI Cell
RNTI
CS Circuit
Switched
CSCF call
session control function
CSAR Cloud Service
Archive
CSI Channel-State
Information
CSI-IM CSI
Interference
Measurement
CSI-RS CSI
Reference Signal
CSI-RSRP CSI
reference signal
received power
CSI-RSRQ CSI
reference signal
received quality
CSI-SINR CSI
signal-to-noise and
interference
ratio
CSMA Carrier Sense
Multiple Access
CSMA/CA CSMA
with collision
avoidance
CSS Common
Search Space, Cell-
specific Search
Space
CTF Charging
Trigger Function
CTS Clear-to-Send
CW Codeword
CWS Contention
Window Size
D2D Device-to-
Device
DC Dual
Connectivity, Direct
Current
DCI Downlink
Control
Information
DF Deployment
Flavour
DL Downlink
DMTF Distributed
Management Task
Force
DPDK Data Plane
Development Kit
DM-RS, DMRS
Demodulation
Reference Signal
DN Data network
DNN Data Network
Name
DNAI Data Network
Access Identifier
DRB Data Radio
Bearer
DRS Discovery
Reference Signal
DRX Discontinuous
Reception
DSL Domain
Specific Language.
Digital
Subscriber Line
DSLAM DSL
Access Multiplexer
DwPTS
Downlink Pilot
Time Slot
E-LAN Ethernet
Local Area Network
E2E End-to-End
ECCA extended clear
channel
assessment,
extended CCA
ECCE Enhanced
Control Channel
Element,
Enhanced CCE
ED Energy
Detection
EDGE Enhanced
Datarates for GSM
Evolution
(GSM Evolution)
EAS Edge
Application Server
EASID Edge
Application Server
Identification
ECS Edge
Configuration Server
ECSP Edge
Computing Service
Provider
EDN Edge
Data Network
EEC Edge
Enabler Client
EECID Edge
Enabler Client
Identification
EES Edge
Enabler Server
EESID Edge
Enabler Server
Identification
EHE Edge
Hosting Environment
EGMF Exposure
Governance
Management
Function
EGPRS
Enhanced
GPRS
EIR Equipment
Identity Register
eLAA enhanced
Licensed Assisted
Access,
enhanced LAA
EM Element
Manager
eMBB Enhanced
Mobile
Broadband
EMS Element
Management System
eNB evolved NodeB,
E-UTRAN Node B
EN-DC E-
UTRA-NR Dual
Connectivity
EPC Evolved Packet
Core
EPDCCH
enhanced
PDCCH, enhanced
Physical
Downlink Control
Cannel
EPRE Energy per
resource element
EPS Evolved Packet
System
EREG enhanced REG,
enhanced resource
element groups
ETSI European
Telecommunications
Standards
Institute
ETWS Earthquake and
Tsunami Warning
System
eUICC embedded
UICC, embedded
Universal
Integrated Circuit
Card
E-UTRA Evolved
UTRA
E-UTRAN Evolved
UTRAN
EV2X Enhanced V2X
F1AP F1 Application
Protocol
F1-C F1 Control
plane interface
F1-U F1 User plane
interface
FACCH Fast
Associated Control
CHannel
FACCH/F Fast
Associated Control
Channel/Full
rate
FACCH/H Fast
Associated Control
Channel/Half
rate
FACH Forward Access
Channel
FAUSCH Fast
Uplink Signalling
Channel
FB Functional
Block
FBI Feedback
Information
FCC Federal
Communications
Commission
FCCH Frequency
Correction CHannel
FDD Frequency
Division Duplex
FDM Frequency
Division
Multiplex
FDMA Frequency
Division Multiple
Access
FE Front End
FEC Forward Error
Correction
FFS For Further
Study
FFT Fast Fourier
Transformation
feLAA further
enhanced Licensed
Assisted
Access, further
enhanced LAA
FN Frame Number
FPGA Field-
Programmable Gate
Array
FR Frequency
Range
FQDN Fully
Qualified Domain
Name
G-RNTI GERAN
Radio Network
Temporary
Identity
GERAN
GSM EDGE
RAN, GSM EDGE
Radio Access
Network
GGSN Gateway GPRS
Support Node
GLONASS
GLObal'naya
NAvigatsionnaya
Sputnikovaya
Sistema (Engl.:
Global Navigation
Satellite
System)
gNB Next
Generation NodeB
gNB-CU gNB-
centralized unit, Next
Generation
NodeB
centralized unit
gNB-DU gNB-
distributed unit, Next
Generation
NodeB
distributed unit
GNSS Global
Navigation Satellite
System
GPRS General Packet
Radio Service
GPSI Generic
Public Subscription
Identifier
GSM Global System
for Mobile
Communications,
Groupe Spécial
Mobile
GTP GPRS
Tunneling Protocol
GTP-UGPRS
Tunnelling Protocol
for User Plane
GTS Go To Sleep
Signal (related
to WUS)
GUMMEI Globally
Unique MME
Identifier
GUTI Globally
Unique Temporary
UE Identity
HARQ Hybrid ARQ,
Hybrid
Automatic
Repeat Request
HANDO Handover
HFN HyperFrame
Number
HHO Hard Handover
HLR Home Location
Register
HN Home Network
HO Handover
HPLMN Home
Public Land Mobile
Network
HSDPA High
Speed Downlink
Packet Access
HSN Hopping
Sequence Number
HSPA High Speed
Packet Access
HSS Home
Subscriber Server
HSUPA High
Speed Uplink Packet
Access
HTTP Hyper Text
Transfer Protocol
HTTPS Hyper
Text Transfer Protocol
Secure (https is
http/1.1 over
SSL, i.e. port 443)
I-Block
Information
Block
ICCID Integrated
Circuit Card
Identification
IAB Integrated
Access and
Backhaul
ICIC Inter-Cell
Interference
Coordination
ID Identity,
identifier
IDFT Inverse Discrete
Fourier
Transform
IE Information
element
IBE In-Band
Emission
IEEE Institute of
Electrical and
Electronics
Engineers
IEI Information
Element
Identifier
IEIDL Information
Element
Identifier Data
Length
IETF Internet
Engineering Task
Force
IF Infrastructure
IM Interference
Measurement,
Intermodulation,
IP Multimedia
IMC IMS
Credentials
IMEI International
Mobile
Equipment
Identity
IMGI International
mobile group identity
IMPI IP Multimedia
Private Identity
IMPU IP Multimedia
PUblic identity
IMS IP Multimedia
Subsystem
IMSI International
Mobile
Subscriber
Identity
IoT Internet of
Things
IP Internet
Protocol
Ipsec IP Security,
Internet Protocol
Security
IP-CAN IP-
Connectivity Access
Network
IP-M IP Multicast
IPv4 Internet
Protocol Version 4
IPv6 Internet
Protocol Version 6
IR Infrared
IS In Sync
IRP Integration
Reference Point
ISDN Integrated
Services Digital
Network
ISIM IM Services
Identity Module
ISO International
Organisation for
Standardisation
ISP Internet Service
Provider
IWF Interworking-
Function
I-WLAN
Interworking
WLAN
Constraint
length of the
convolutional
code, USIM
Individual key
kB Kilobyte (1000
85 bytes)
kbps kilo-bits per
second
Kc Ciphering key
Ki Individual
subscriber
authentication
key
KPI Key
Performance Indicator
KQI Key Quality
Indicator
KSI Key Set
Identifier
ksps kilo-symbols
per second
KVM Kernel Virtual
Machine
L1 Layer 1
(physical layer)
L1-RSRP Layer 1
reference signal
received power
L2 Layer 2 (data
link layer)
L3 Layer 3
(network layer)
LAA Licensed
Assisted Access
LAN Local Area
Network
LADN Local
Area Data Network
LBT Listen Before
Talk
LCM LifeCycle
Management
LCR Low Chip Rate
LCS Location
Services
LCID Logical
Channel ID
LI Layer Indicator
LLC Logical Link
Control, Low Layer
Compatibility
LPLMN Local
PLMN
LPP LTE
Positioning Protocol
LSB Least
Significant Bit
LTE Long Term
Evolution
LWA LTE-WLAN
aggregation
LWIP LTE/WLAN
Radio Level
Integration with
IPsec Tunnel
LTE Long Term
Evolution
M2M Machine-to-
Machine
MAC Medium Access
Control
(protocol
layering context)
MAC Message
authentication code
(security/encryption
context)
MAC-A MAC
used for
authentication
and key
agreement
(TSG T WG3 context)
MAC-IMAC used for
data integrity of
signalling messages
(TSG T WG3 context)
MANO
Management
and Orchestration
MBMS
Multimedia
Broadcast and
Multicast
Service
MBSFN
Multimedia
Broadcast
multicast
service Single
Frequency
Network
MCC Mobile Country
Code
MCG Master Cell
Group
MCOT Maximum
Channel
Occupancy
Time
MCS Modulation and
coding scheme
MDAF Management
Data Analytics
Function
MDAS Management
Data Analytics
Service
MDT Minimization of
Drive Tests
ME Mobile
Equipment
MeNB master eNB
MER Message Error
Ratio
MGL Measurement
Gap Length
MGRP Measurement
Gap Repetition
Period
MIB Master
Information Block,
Management
Information Base
MIMO Multiple Input
Multiple Output
MLC Mobile
Location Centre
MM Mobility
Management
MME Mobility
Management Entity
MN Master Node
MNO Mobile
Network Operator
MO Measurement
Object, Mobile
Originated
MPBCH MTC
Physical Broadcast
CHannel
MPDCCH MTC
Physical Downlink
Control
CHannel
MPDSCH MTC
Physical Downlink
Shared
CHannel
MPRACH MTC
Physical Random
Access
CHannel
MPUSCH MTC
Physical Uplink Shared
Channel
MPLS MultiProtocol
Label Switching
MS Mobile Station
MSB Most
Significant Bit
MSC Mobile
Switching Centre
MSI Minimum
System
Information,
MCH Scheduling
Information
MSID Mobile Station
Identifier
MSIN Mobile Station
Identification
Number
MSISDN Mobile
Subscriber ISDN
Number
MT Mobile
Terminated, Mobile
Termination
MTC Machine-Type
Communications
mMTCmassive MTC,
massive
Machine-Type
Communications
MU-MIMO Multi
User MIMO
MWUS MTC
wake-up signal, MTC
WUS
NACK Negative
Acknowledgement
NAI Network
Access Identifier
NAS Non-Access
Stratum, Non-Access
Stratum layer
NCT Network
Connectivity
Topology
NC-JT Non-
Coherent Joint
Transmission
NEC Network
Capability
Exposure
NE-DC NR-E-
UTRA Dual
Connectivity
NEF Network
Exposure Function
NF Network
Function
NFP Network
Forwarding Path
NFPD Network
Forwarding Path
Descriptor
NFV Network
Functions
Virtualization
NFVI NFV
Infrastructure
NFVO NFV
Orchestrator
NG Next
Generation, Next Gen
NGEN-DC NG-
RAN E-UTRA-NR
Dual Connectivity
NM Network
Manager
NMS Network
Management System
N-PoP Network Point
of Presence
NMIB, N-MIB
Narrowband MIB
NPBCH
Narrowband
Physical
Broadcast
CHannel
NPDCCH
Narrowband
Physical
Downlink
Control CHannel
NPDSCH
Narrowband
Physical
Downlink
Shared CHannel
NPRACH
Narrowband
Physical Random
Access CHannel
NPUSCH
Narrowband
Physical Uplink
Shared CHannel
NPSS Narrowband
Primary
Synchronization
Signal
NSSS Narrowband
Secondary
Synchronization
Signal
NR New Radio,
Neighbour Relation
NRF NF Repository
Function
NRS Narrowband
Reference Signal
NS Network
Service
NSA Non-Standalone
operation mode
NSD Network
Service Descriptor
NSR Network
Service Record
NSSAI Network Slice
Selection
Assistance
Information
S-NNSAI Single-
NSSAI
NSSF Network Slice
Selection Function
NW Network
NWUSNarrowband
wake-up signal,
Narrowband WUS
NZP Non-Zero
Power
O&M Operation and
Maintenance
ODU2 Optical channel
Data Unit - type 2
OFDMOrthogonal
Frequency Division
Multiplexing
OFDMA
Orthogonal
Frequency Division
Multiple Access
OOB Out-of-band
OOS Out of
Sync
OPEX OPerating
EXpense
OSI Other System
Information
OSS Operations
Support System
OTA over-the-air
PAPR Peak-to-
Average Power
Ratio
PAR Peak to
Average Ratio
PBCH Physical
Broadcast Channel
PC Power Control,
Personal
Computer
PCC Primary
Component Carrier,
Primary CC
P-CSCF Proxy
CSCF
PCell Primary Cell
PCI Physical Cell
ID, Physical Cell
Identity
PCEF Policy and
Charging
Enforcement
Funation
PCF Polcy Control
Function
PCRF Policy Control
and Charging Rules
Function
PDCP Packet Data
Convergence
Protocol, Packet
Data Covergence
Protocol layer
PDCCH Physical
Downlink Control
Channel
PDCP Packet Data
Convergence Protocol
PDN Packet Data
Network, Public
Data Network
PDSCH Physical
Downlink Shared
Channel
PDU Protocol Date
Unit
PEI Permanent
Equipment
Identifiers
PFD Packet Flow
Description
P-GW PDN Gateway
PDICH Physical
hybrid-ARQ indicator
channel
PHY Physical layer
PLMN Public Land
Mobile Network
PIN Personal
Identification Number
PM Performance
Measurement
PMI Precoding
Matrix Indicator
PNF Physical
Network Function
PNFD Physical
Network Function
Descriptor
PNFR Physical
Network Function
Record
POC PTT over
Cellular
PP, PTP Point-to-
Point
PPP Point-to-Point
Protocol
PRACH Physical
RACH
PRB Physical
resource block
PRG Physical
resource block
group
ProSe Proximity
Services,
Proximity-
Based Service
PRS Positioning
Reference Signal
PRR Packet
Reception Radio
PS Packet Services
PSBCH Physical
Sidelink Broadcast
Channel
PSDCH Physical
Sidelink Downlink
Channel
PSCCH Physical
Sidelink Control
Channel
PSSCH Physical
Sidelink Shared
Channel
PSCell Primary SCell
PSS Primary
Synchronization
Signal
PSTN Public Switched
Telephone Network
PT-RS Phase-tracking
reference signal
PTT Push-to-Talk
PUCCH Physical
Uplink Control
Channel
PUSCH Physical
Uplink Shared
Channel
QAM Quadrature
Amplitude
Modulation
QCI QoS class of
identifier
QCL Quasi co-
location
QFI QoS Flow ID,
QoS Flow
Identifier
QoS Quality of
Service
QPSK Quadrature
(Quaternary) Phase
Shift Keying
QZSS Quasi-Zenith
Satellite System
RA-RNTI Random
Access RNTI
RAB Radio Access
Bearer, Random
Access Burst
RACH Random Access
Channel
RADIUS Remote
Authentication Dial
In User Service
RAN Radio Access
Network
RAND RANDom
number (used for
authentication)
RAR Random Access
Response
RAT Radio Access
Technology
RAU Routing Area
Update
RB Resource block,
Radio Bearer
RBG Resource block
group
REG Resource
Element Group
Rel Release
REQ REQuest
RF Radio
Frequency
RI Rank Indicator
RIV Resource
indicator value
RL Radio Link
RLC Radio Link
Control, Radio
Link Control
layer
RLC AM RLC
Acknowledged Mode
RLC UM RLC
Unacknowledged
Mode
RLF Radio Link
Failure
RLM Radio Link
Monitoring
RLM-RS
Reference
Signal for RLM
RM Registration
Management
RMC Reference
Measurement Channel
RMSI Remaining
MSI, Remaining
Minimum
System
Information
RN Relay Node
RNC Radio Network
Controller
RNL Radio Network
Layer
RNTI Radio Network
Temporary
Identifier
ROHC RObust Header
Compression
RRC Radio Resource
Control, Radio
Resource Control
layer
RRM Radio Resource
Management
RS Reference
Signal
RSRP Reference
Signal Received
Power
RSRQ Reference
Signal Received
Quality
RSSI Received Signal
Strength
Indicator
RSU Road Side Unit
RSTD Reference
Signal Time
difference
RTP Real Time
Protocol
RTS Ready-To-Send
RTT Round Trip
Time
Rx Reception,
Receiving, Receiver
S1AP S1 Application
Protocol
S1-MME S1 for
the control plane
S1-U S1 for the user
plane
S-CSCF serving
CSCF
S-GW Serving
Gateway
S-RNTI SRNC
Radio Network
Temporary
Identity
S-TMSI SAE
Temporary Mobile
Station
Identifier
SA Standalone
operation mode
SAE System
Architecture
Evolution
SAP Service Access
Point
SAPD Service Access
Point Descriptor
SAPI Service Access
Point Identifier
SCC Secondary
Component Carrier,
Secondary CC
SCell Secondary Cell
SCEF Service
Capability Exposure
Function
SC-FDMA Single
Carrier Frequency
Division
Multiple Access
SCG Secondary Cell
Group
SCM Security
Context
Management
SCS Subcarrier
Spacing
SCTP Stream Control
Transmission
Protocol
SDAP Service Data
Adaptation
Protocol,
Service Data
Adaptation
Protocol layer
SDL Supplementary
Downlink
SDNF Structured Data
Storage Network
Function
SDP Session
Description Protocol
SDSF Structured Data
Storage Function
SDU Service Data
Unit
SEAF Security
Anchor Function
SeNB secondary eNB
SEPP Security Edge
Protection Proxy
SFI Slot format
indication
SFTD Space-
Frequency Time
Diversity, SFN
and frame timing
difference
SFN System Frame
Number
SgNB Secondary gNB
SGSN Serving GPRS
Support Node
S-GW Serving
Gateway
SI System
Information
SI-RNTI System
Information RNTI
SIB System
Information Block
SIM Subscriber
Identity Module
SIP Session
Initiated Protocol
SiP System in
Package
SL Sidelink
SLA Service Level
Agreement
SM Session
Management
SMF Session
Management Function
SMS Short Message
Service
SMSF SMS Function
SMTC SSB-based
Measurement Timing
Configuration
SN Secondary
Node, Sequence
Number
SoC System on Chip
SON Self-Organizing
Network
SpCell Special Cell
SP-CSI-RNTISemi-
Persistent CSI RNTI
SPS Semi-Persistent
Scheduling
SQN Sequence
number
SR Scheduling
Request
SRB Signalling
Radio Bearer
SRS Sounding
Reference Signal
SS Synchronization
Signal
SSB Synchronization
Signal Block
SSID Service Set
Identifier
SS/PBCH Block
SSBRI SS/PBCH
Block Resource
Indicator,
Synchronization
Signal Block
Resource
Indicator
SSC Session and
Service
Continuity
SS-RSRP
Synchronization
Signal based
Reference
Signal Received
Power
SS-RSRQ
Synchronization
Signal based
Reference
Signal Received
Quality
SS-SINR
Synchronization
Signal based Signal
to Noise and
Interference Ratio
SSS Secondary
Synchronization
Signal
SSSG Search Space
Set Group
SSSIF Search Space
Set Indicator
SST Slice/Service
Types
SU-MIMO Single
User MIMO
SUL Supplementary
Uplink
TA Timing
Advance, Tracking
Area
TAC Tracking Area
Code
TAG Timing
Advance Group
TAI
Tracking Area
Identity
TAU Tracking Area
Update
TB Transport Block
TBS Transport Block
Size
TBD To Be Defined
TCI Transmission
Configuration
Indicator
TCP Transmission
Communication
Protocol
TDD Time Division
Duplex
TDM Time Division
Multiplexing
TDMATime Division
Multiple Access
TE Terminal
Equipment
TEID Tunnel End
Point Identifier
TFT Traffic Flow
Template
TMSI Temporary
Mobile
Subscriber
Identity
TNL Transport
Network Layer
TPC Transmit Power
Control
TPMI Transmitted
Precoding Matrix
Indicator
TR Technical
Report
TRP, TRxP
Transmission
Reception Point
TRS Tracking
Reference Signal
TRx Transceiver
TS Technical
Specifications,
Technical
Standard
TTI Transmission
Time Interval
Tx Transmission,
Transmitting,
Transmitter
U-RNTI UTRAN
Radio Network
Temporary
Identity
UART Universal
Asynchronous
Receiver and
Transmitter
UCI Uplink Control
Information
UE User Equipment
UDM Unified Data
Management
UDP User Datagram
Protocol
UDSF Unstructured
Data Storage Network
Function
UICC Universal
Integrated Circuit
Card
UL Uplink
UM
Unacknowledged
Mode
UML Unified
Modelling Language
UMTS Universal
Mobile
Telecommunications
System
UP User Plane
UPF User Plane
Function
URI Uniform
Resource Identifier
URL Uniform
Resource Locator
URLLC Ultra-
Reliable and Low
Latency
USB Universal Serial
Bus
USIM Universal
Subscriber Identity
Module
USS UE-specific
search space
UTRA UMTS
Terrestrial Radio
Access
UTRAN
Universal
Terrestrial Radio
Access
Network
UwPTS Uplink
Pilot Time Slot
V2I Vehicle-to-
Infrastruction
V2P Vehicle-to-
Pedestrian
V2V Vehicle-to-
Vehicle
V2X Vehicle-to-
everything
VIM Virtualized
Infrastructure Manager
VL Virtual Link,
VLAN Virtual LAN,
Virtual Local Area
Network
VM Virtual
Machine
VNF Virtualized
Network Function
VNFFG VNF
Forwarding Graph
VNFFGD VNF
Forwarding Graph
Descriptor
VNFM VNF Manager
VoIP Voice-over-IP,
Voice-over- Internet
Protocol
VPLMN Visited
Public Land Mobile
Network
VPN Virtual Private
Network
VRB Virtual
Resource Block
WiMAX
Worldwide
Interoperability
for Microwave
Access
WLANWireless Local
Area Network
WMAN Wireless
Metropolitan Area
Network
WPANWireless
Personal Area Network
X2-C X2-Control
plane
X2-U X2-User plane
XML eXtensible
Markup
Language
XRES EXpected user
RESponse
XOR eXclusive OR
ZC Zadoff-Chu
ZP Zero Power

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes.

Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-22. (canceled)

23. An apparatus comprising:
memory to store configuration information for a first search space set group (SSSG) and a second SSSG associated with respective first and second physical downlink control channel (PDCCH) monitoring configurations; and
processing circuitry, coupled with the memory, to:
retrieve the configuration information from the memory; and
encode a message for transmission to a user equipment (UE) that includes the configuration information, wherein the configuration information includes an indication of a boundary for switching between the first SSSG and the second SSSG that is aligned with a boundary of a slot group.

24. The apparatus of claim 23, wherein the processing circuitry is further to:
encode a first PDCCH for transmission in the first SSSG based on the first PDCCH monitoring configuration; and
encode a second PDCCH for transmission in the second SSSG based on the second PDCCH monitoring configuration.

25. The apparatus of claim 23, wherein one or more of the first PDCCH monitoring configuration and the second PDCCH monitoring configuration includes respective PDCCH monitoring occasions in up to Y consecutive slots within respective slot groups of X consecutive slots.

26. The apparatus of claim 25, wherein the first PDCCH monitoring configuration and second PDDCH monitoring configuration include: a common value for X but a different value for Y, or a common value for Y but a different value for X, or a different value for Y and a different value for X.

27. The apparatus of claim 25, wherein:
Z slots around the boundary for switching between the first SSSG and the second SSSG are empty without PDCCH monitoring; or
Z slots around the boundary for switching between the first SSSG and the second SSSG are to include PDCCH monitoring based on respective values for X and Y in the first PDCCH monitoring configuration and second PDDCH monitoring configuration.

28. The apparatus of claim 23, wherein the switching between the first SSSG and second SSSG includes switching between two different PDCCH monitoring capabilities for a maximum number of monitored PDCCH candidates and non-overlapped control channel elements (CCEs).

29. The apparatus of claim 23, wherein the slot groups are consecutive and non-overlapping.

30. The apparatus of claim 23, wherein a start of a first slot group in a subframe is aligned with a boundary of the subframe.

31. One or more computer-readable media storing instructions that, when executed by one or more processors, cause a next-generation NodeB (gNB) to:
determine configuration information for a first search space set group (SSSG) and a second SSSG associated with respective first and second physical downlink control channel (PDCCH) monitoring configurations, wherein the configuration information includes an indication of a boundary for switching between the first SSSG and the second SSSG that is aligned with a boundary of a slot group;
encode a message for transmission to a user equipment (UE) that includes the configuration information;
encode a first PDCCH for transmission in the first SSSG based on the first PDCCH monitoring configuration; and
encode a second PDCCH for transmission in the second SSSG based on the second PDCCH monitoring configuration.

32. The one or more computer readable media of claim 31, wherein one or more of the first PDCCH monitoring configuration and the second PDCCH monitoring configuration includes respective PDCCH monitoring occasions in up to Y consecutive slots within respective slot groups of X consecutive slots.

33. The one or more computer readable media of claim 32, wherein the first PDCCH monitoring configuration and second PDDCH monitoring configuration include: a common value for X but a different value for Y, or a common value for Y but a different value for X, or a different value for Y and a different value for X.

34. The one or more computer readable media of claim 32, wherein:
Z slots around the boundary for switching between the first SSSG and the second SSSG are empty without PDCCH monitoring; or
Z slots around the boundary for switching between the first SSSG and the second SSSG are to include PDCCH monitoring based on respective values for X and Y in the first PDCCH monitoring configuration and second PDDCH monitoring configuration.

35. The one or more computer readable media of claim 31, wherein the switching between the first SSSG and second SSSG includes switching between two different PDCCH monitoring capabilities for a maximum number of monitored PDCCH candidates and non-overlapped control channel elements (CCEs).

36. The one or more computer readable media of claim 31,
wherein the slot groups are consecutive and non-overlapping; or
wherein a start of a first slot group in a subframe is aligned with a boundary of the subframe.

37. One or more computer-readable media storing instructions that, when executed by one or more processors, cause a user equipment (UE) to:
receive, from a next-generation NodeB (gNB), configuration information for a first search space set group (SSSG) and a second SSSG associated with respective first and second physical downlink control channel (PDCCH) monitoring configurations, wherein the configuration information includes an indication of a boundary for switching between the first SSSG and the second SSSG that is aligned with a boundary of a slot group;
monitor PDCCH in the first SSSG based on the first PDCCH monitoring configuration; and
monitor PDCCH in the second SSSG based on the second PDCCH monitoring configuration.

38. The one or more computer readable media of claim 37, wherein one or more of the first PDCCH monitoring configuration and the second PDCCH monitoring configuration includes respective PDCCH monitoring occasions in up to Y consecutive slots within respective slot groups of X consecutive slots.

39. The one or more computer readable media of claim 38, wherein the first PDCCH monitoring configuration and second PDDCH monitoring configuration include: a common value for X but a different value for Y, or a common value for Y but a different value for X, or a different value for Y and a different value for X.

40. The one or more computer readable media of claim 38, wherein:
Z slots around the boundary for switching between the first SSSG and the second SSSG are empty without PDCCH monitoring; or
Z slots around the boundary for switching between the first SSSG and the second SSSG are to include PDCCH monitoring based on respective values for X and Y in the first PDCCH monitoring configuration and second PDDCH monitoring configuration.

41. The one or more computer readable media of claim 37, wherein the switching between the first SSSG and second SSSG includes switching between two different PDCCH monitoring capabilities for a maximum number of monitored PDCCH candidates and non-overlapped control channel elements (CCEs).

42. The one or more computer readable media of claim 37,
wherein the slot groups are consecutive and non-overlapping; or
wherein a start of a first slot group in a subframe is aligned with a boundary of the subframe.
